(19) United States
(12) Patent Application Publication
(10) Pub. No.: US 2026/0067915 A1
(43) Pub. Date: Mar. 5, 2026

(54) SYSTEMS, METHODS, AND DEVICES FOR SMART UPLINK AND DOWNLINK RESOURCE MANAGEMENT

(71) Applicant: Apple Inc., Cupertino, CA (US)

(72) Inventors: Raghuveer MALLIKARJUNAN, Sunnyvale, CA (US); Erdogan DEDE, San Diego, CA (US); Muthukumaran DHANAPAL, San Diego, CA (US)

(21) Appl. No.: 18/820,036

(22) Filed: Aug. 29, 2024

(51) Int. Cl. H04W 72/50

(52) U.S. Cl. CPC H04W 72/535

(57) ABSTRACT

The techniques described herein may include solutions for enabling a user equipment (UE) to monitor uplink (UL) traffic of an application or wireless link, detect an increase in UL traffic, and communicate with a base station, satellite, etc. to dynamically increase UL resources. The increase in UL resource can include a change in the number of UL slots per frame. The UE can determine the UL requirements of the application, assess a current usage of UL resources, verify that downlink (DL) resources are underused, and more. UL performance can be increased without a meaningful decrease in DL performance, as the increase in UL resources can be achieved by a corresponding decrease in DL resources.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks may be developed to implement fourth generation (4G), fifth generation (5G) or new radio (NR) technology. Such technology may include solutions for enabling user equipment (UE) and network devices, such as base stations, to communicate with one another. Some scenarios may involve enabling or configuring a UE to communicate with multiple network devices.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of an example of an overview a smart uplink resource management for challenging uplink environments according to one or more implementations described herein.

FIG. 2 is a diagram of an example network according to one or more implementations described herein.

FIG. 3 is a diagram of an example of a process for a smart uplink (UL) resource management according to one or more implementations described herein.

FIG. 4 is a diagram of an example of a sequence flow diagram of an example of a process for a smart uplink resource management according to one or more implementations described herein.

FIG. 5 is a diagram of an example of a smart uplink resource management algorithm according to one or more implementations described herein.

FIG. 6 is a diagram of an example of a graph of an energy performance of smart uplink resource management according to one or more implementations described herein.

FIG. 7 is a diagram of an example of a graph of UL transmissions latencies under various conditions according to one or more implementations described herein.

FIG. 8 is a diagram of an example of components of a device according to one or more implementations described herein.

FIG. 9 is a diagram of an example interfaces of baseband circuitry according to one or more implementations described herein.

FIG. 10 is a diagram of an example of components, according to one or more implementations described herein, able to read instructions from a machine-readable or computer-readable medium (e.g., a non-transitory machine-readable storage medium) and perform any one or more of the methodologies discussed herein.

FIG. 11 is a diagram of an example process for a smart UL resource management according to one or more implementations described herein.

FIG. 12 is a diagram of an example process for a smart UL resource management according to one or more implementations described herein.

FIG. 13 is a diagram of an example process for a smart DL resource management according to one or more implementations described herein.

FIG. 14 is a diagram of an example process for a smart DL resource management according to one or more implementations described herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Telecommunication networks may include user equipment (UEs) capable of communicating with base stations and/or other network access nodes, such as satellites. UEs, base stations, and satellites can implement various techniques and communications standards for enabling UEs and base stations to discover one another, establish and maintain connectivity, and exchange information in an ongoing manner. An aspect of interest in telecommunications may include ensuring that UEs are able to communicate a desired amount of uplink (UL) information at a desired rate.

In 5th generation (5G) new radio (NR) networks, uplink (UL) bandwidth can be a bottleneck to communicating under certain conditions. These can include when the UE uses applications that generate significant UL traffic, has limited coverage, engages in mobile edge compute scenarios (e.g., where the UE is to offload data and processes to edge servers, application servers or another type of network server), is limited to communicating with satellites, and so on. Herein, terms such as “offload,” “offloading,” and so on, can refer to the transfer of data and/or processes (e.g., resource-intensive tasks) from the UE to network resources (e.g., edge servers) to optimize or otherwise reallocate the use of processing and memory resources. Offloading resource-intensive tasks to the network enhance application performance and reduces UE strain (e.g., UE temperature) and power consumption rates (e.g., improves battery life).

An example of applications that generate significant UL traffic and/or engage in mobile edge commuting can include video game application, VR applications, and other data-intensive applications. Additionally, whether an application generates significant UL traffic can be relative to the UL resources allocated to the UE. For example, the UE can be allocated limited UL resources when communicating with a satellite system via 5G communication standards. In such scenarios, a messaging application could be a high volume UL traffic application when communicating via the satellite system, while the same messaging application could be a lower volume UL traffic application when communicating with a wireless router via WiFi®.

5G downlink (DL) performance can be comparable to WiFi® in terms of, for example, latency (e.g., round trip time (RTT)), power or energy efficiency (e.g., nanoJoule/byte of DL packets)), and more. By contrast, 5G UL performance can be limited in comparison with the same metrics when transfer size and/or cadence exceed certain thresholds. Satellite communications with UE can exhibit similar constraints on UL, such that UL throughput can drop to 20 times lower than DL throughput in some examples. This can, in turn, limit the use of satellite connects to certain types of services, such as road-side assistance or other emergency services.

One or more of the techniques described herein provide solutions that address these and other deficiencies of 5G mobile edge compute and satellite communications by dynamically increasing UL performance without degrading DL performance. In particular, the techniques can enable a UE to request additional resources from the network to improve UL performance based on UL traffic conditions, application UL requirements, the current usage of DL resources, one or more key performance indicators (KPIs), and more.

A UE can monitor UL traffic of an application or wireless link, detect an increase in UL traffic, and communicate with the network to dynamically increase UL resources. The increase in UL resource can include a change in the number of UL slots per frame. In doing so, the UE can also determine the UL requirements of the application, assess a current usage of UL resources, and more. For example, the UE can verify that DL resources are underused, before requesting an increase in UL resource. In so doing, UL performance can be increased without a meaningful decrease in DL performance, as the increase in UL resources can be achieved by a decrease DL resources. Dynamically increasing the UL resources can enable the UE to improve UL performance commensurate with the requirements or preferences of applications that generate significant UL traffic, engage in edge compute offloading, and more.

The UE can also determine whether to increase UL resources based one or more key performance indicator conditions (KPIs). Examples of such criteria can include a latency measured by the UE, UE power conditions, transmission (Tx) power requirements, and more. Additional details and examples of these techniques, and others, are discussed below with reference to the following Figures.

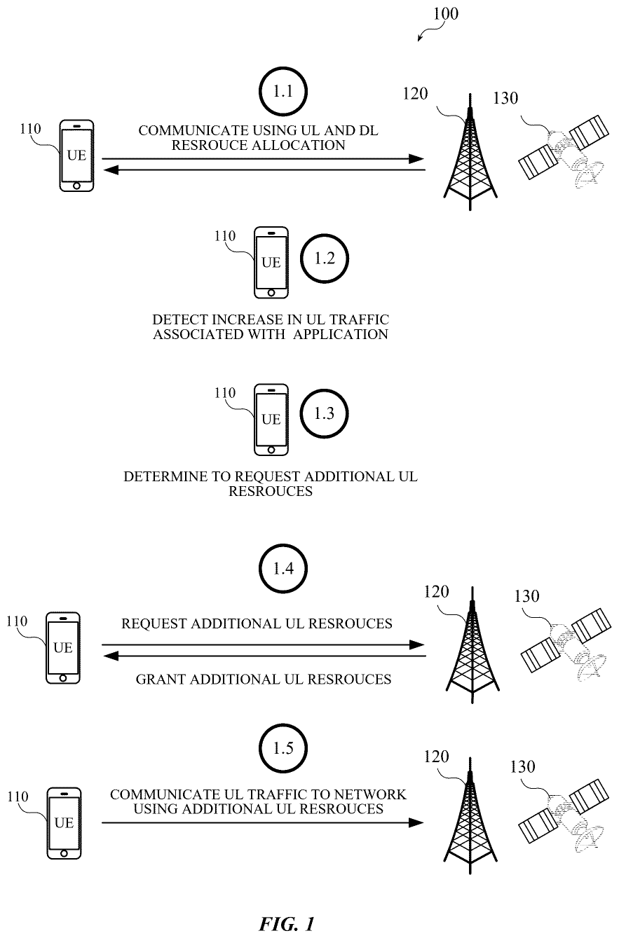

FIG. 1 is a diagram of an example of an overview 100 a smart UL resource management according to one or more implementations described herein. As shown, overview 100 can include UE 110, base station 120, and satellite 130. UE 110 can communicate with base station 120 and/or satellite 130 based on an initial allocation of UL and DL resources (at 1.1).

In such an environment, bandwidth constraints on uplink traffic can require UE 110 to request additional UL resources from the network in order to offload large transfers to edge servers. Accordingly, as shown, UE 110 is in communication with a base station 222 or satellite 260 (at 1.1). UE 110 can detect or determine an increase in UL traffic. (at 1.2). The increase in UL traffic can be based on requirements or preferences of an application executed by UE 110 and/or UL traffic actually being generated by an application executed by UE 110.

Based on the increase in UL traffic, UE 110 can determine a need or preference for additional UL resources (at 1.3). UE 110 can do so based on one or more factors, such as the UL preferences of the application, the actual UL data generated by the application (e.g., the size of a UL transfer), and/or one or more KPIs, factors, or conditions. Examples of KPIs, factors, or conditions can include currently available UL bandwidth, UL throughput, a signal-to-noise ratio (SNR), latency, RTT, current batter power, and more.

UE 110 can transmit a request for additional UL resources to the network via base station 120 or satellite 130 (at 1.4). The request can include an increase in the number of UL slots per frame. In some implementations, the request can also, or alternatively, include a decrease in the number of DL slots per frame. In response, the network can send UE 110 a resource grant that includes additional UL resources (e.g., which can include an increase in the number of UL slots per frame) to enable higher UL throughput. UE 110 can respond by using the additional UL resources to increase the rate and amount of UL traffic sent to edge servers with a higher throughput enabled by communicating UL traffic to the network base station 120 or satellite 130 (at 1.5). Additional details and examples of these techniques, and others, are discussed below with reference to the following Figures.

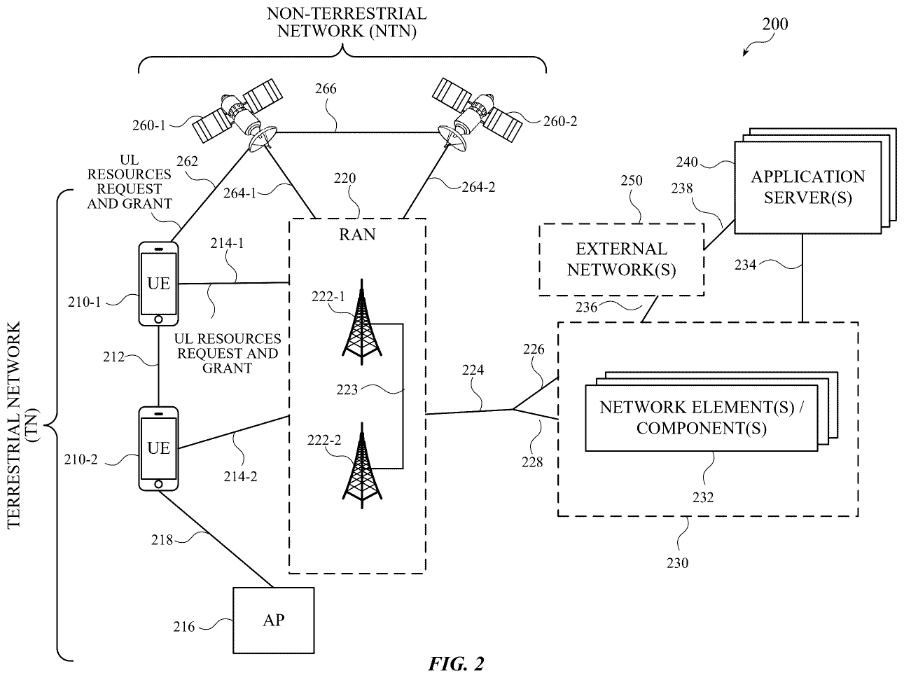

FIG. 2 is an example network 200 according to one or more implementations described herein. Example network 200 can include UEs 210-1, 210-2, etc. (referred to collectively as “UEs 210” and individually as “UE 210”), a radio access network (RAN) 220, a core network (CN) 230, application servers 240, external networks 250, and satellites 260-1, 260-2, etc. (referred to collectively as “satellites 260” and individually as “satellite 260”). As shown, network 200 can include a non-terrestrial network (NTN) comprising one or more satellites 260 (e.g., of a global navigation satellite system (GNSS)) in communication with UEs 210 and RAN 220.

The systems and devices of example network 200 can operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 200 can operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 210 can include smartphones (e.g., handheld touchscreen mobile computing devices connectable to one or more wireless communication networks). Additionally, or alternatively, UEs 210 can include other types of mobile or non-mobile computing devices capable of wireless communications, such as personal data assistants (PDAs), pagers, laptop computers, desktop computers, wireless handsets, etc. In some implementations, UEs 210 can include internet of things (IoT) devices (or IoT UEs) that can comprise a network access layer designed for low-power IoT applications utilizing short-lived UE connections. Additionally, or alternatively, an IoT UE can utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data can be a machine-initiated exchange, and an IoT network can include interconnecting IoT UEs (which can include uniquely identifiable embedded computing devices within an Internet infrastructure) with short-lived connections. In some scenarios, IoT UEs can execute background applications (e.g., keep-alive messages, status updates, etc.) to facilitate the connections of the IoT network.

UEs 210 can communicate and establish a connection with one or more other UEs 210 via one or more wireless channels 212, each of which can comprise a physical communications interface/layer. The connection can include an M2M connection, MTC connection, D2D connection, SL connection, etc. The connection can involve a PC5 interface. In some implementations, UEs 210 can be configured to discover one another, negotiate wireless resources between one another, and establish connections between one another, without intervention or communications involving RAN node 222 or another type of network node. In some implementations, discovery, authentication, resource negotiation, registration, etc., can involve communications with RAN node 222 or another type of network node.

UEs 210 can use one or more wireless channels 212 to communicate with one another. As described herein, UE 210 can communicate with RAN node 222 to request SL resources. RAN node 222 can respond to the request by providing UE 210 with a dynamic grant (DG) or configured grant (CG) regarding SL resources. A DG can include a grant based on a grant request from UE 210. A CG can involve a resource grant without a grant request and can be based on a type of service being provided (e.g., services that have strict timing or latency requirements). UE 210 can perform a clear channel assessment (CCA) procedure based on the DG or CG, select SL resources based on the CCA procedure and the DG or CG; and communicate with another UE 210 based on the SL resources. The UE 210 can communicate with RAN node 222 using a licensed frequency band and communicate with the other UE 210 using an unlicensed frequency band.

UEs 210 can communicate and establish a connection with RAN 220, which can involve one or more wireless channels 214-1 and 214-2, each of which can comprise a physical communications interface/layer. In some implementations, a UE can be configured with dual connectivity (DC) as a multi-radio access technology (multi-RAT) or multi-radio dual connectivity (MR-DC), where a multiple receive and transmit (Rx/Tx) capable UE can use resources provided by different network nodes (e.g., 222-1 and 222-2) that can be connected via non-ideal backhaul (e.g., where one network node provides NR access and the other network node provides either E-UTRA for LTE or NR access for 5G). A network node can be referred to herein as a base station 222. In such a scenario, one network node can operate as a master node (MN) and the other as the secondary node (SN). The MN and SN can be connected via a network interface, and at least the MN can be connected to the CN 230. Additionally, at least one of the MN or the SN can be operated with shared spectrum channel access, and functions specified for UE 210 can be used for an integrated access and backhaul mobile termination (IAB-MT). Similar for UE 210, the IAB-MT can access the network using either one network node or using two different nodes with enhanced dual connectivity (EN-DC) architectures, new radio dual connectivity (NR-DC) architectures, or the like. In some implementations, a base station (as described herein) can be an example of network node 222. In some scenarios, RAN 220 can coordinate with core network 230 via interfaces 224, 226, and/or 228.

In some scenarios, UE 210 can perform one or more operations enable collaborative estimation of UE locations. The operation(s) can include determining that UE 210 is moving with other UEs 210 and forming a group with the other UEs 210. Additionally, UEs 210 can determine their locations collaboratively, based on location information and/or location information metadata exchanged between UEs 210.

As shown, UE 210 can also, or alternatively, connect to access point (AP) 216 via connection interface 218, which can include an air interface enabling UE 210 to communicatively couple with AP 216. AP 216 can comprise a wireless local area network (WLAN), WLAN node, WLAN termination point, etc. The connection 216 can comprise a local wireless connection, such as a connection consistent with any IEEE 702.11 protocol, and AP 216 can comprise a wireless fidelity (Wi-Fi®) router or other AP. While not explicitly depicted in FIG. 2, AP 216 can be connected to another network (e.g., the Internet) without connecting to RAN 220 or CN 230. In some scenarios, UE 210, RAN 220, and AP 216 can be configured to utilize LTE-WLAN aggregation (LWA) techniques or LTE WLAN radio level integration with IPsec tunnel (LWIP) techniques. LWA can involve UE 210 in RRC_CONNECTED being configured by RAN 220 to utilize radio resources of LTE and WLAN. LWIP can involve UE 210 using WLAN radio resources (e.g., connection interface 218) via IPsec protocol tunneling to authenticate and encrypt packets (e.g., Internet Protocol (IP) packets) communicated via connection interface 218. IPsec tunneling can include encapsulating the entirety of original IP packets and adding a new packet header, thereby protecting the original header of the IP packets.

RAN 220 can include one or more RAN nodes 222-1 and 222-2 (referred to collectively as RAN nodes 222, and individually as RAN node 222) that enable channels 214-1 and 214-2 to be established between UEs 210 and RAN 220. RAN nodes 222 can include network access points configured to provide radio baseband functions for data and/or voice connectivity between users and the network based on one or more of the communication technologies described herein (e.g., 2G, 3G, 4G, 5G, WiFi, etc.). As examples therefore, a RAN node can be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 222 can include a roadside unit (RSU), a transmission reception point (TRxP or TRP), and one or more other types of ground stations (e.g., terrestrial access points). In some scenarios, RAN node 222 can be a dedicated physical device, such as a macrocell base station, and/or a low power (LP) base station for providing femtocells, picocells or the like having smaller coverage areas, smaller user capacity, or higher bandwidth compared to macrocells. A RAN node can generally be referred to herein as base station 222. Satellites 260 can operate as RAN nodes 222, with respect to UEs 210. As such, references herein to a base station, RAN node 222, etc., can involve implementations where the base station, RAN node 222, etc., is a terrestrial network (TN) node and also to implementation where the base station, RAN node 222, etc., is an NTN node (e.g., satellite 260).

Some or all of RAN nodes 222, or portions thereof, can be implemented as one or more software entities running on server computers as part of a virtual network, which can be referred to as a centralized RAN (CRAN) and/or a virtual baseband unit pool (vBBUP). In these implementations, the CRAN or vBBUP can implement a RAN function split, such as a packet data convergence protocol (PDCP) split wherein radio resource control (RRC) and PDCP layers can be operated by the CRAN/vBBUP and other Layer 2 (L2) protocol entities can be operated by individual RAN nodes 222; a media access control (MAC)/physical (PHY) layer split wherein RRC, PDCP, radio link control (RLC), and MAC layers can be operated by the CRAN/vBBUP and the PHY layer can be operated by individual RAN nodes 222; or a “lower PHY” split wherein RRC, PDCP, RLC, MAC layers and upper portions of the PHY layer can be operated by the CRAN/vBBUP and lower portions of the PHY layer can be operated by individual RAN nodes 222. This virtualized framework can allow freed-up processor cores of RAN nodes 222 to perform or execute other virtualized applications.

In some implementations, an individual RAN node 222 can represent individual gNB-distributed units (DUs) connected to a gNB-control unit (CU) via individual F1 or other interfaces. In such implementations, the gNB-DUs can include one or more remote radio heads or radio frequency (RF) front end modules (RFEMs), and the gNB-CU can be operated by a server (not shown) located in RAN 220 or by a server pool (e.g., a group of servers configured to share resources) in a similar manner as the CRAN/vBBUP. Additionally, or alternatively, one or more of RAN nodes 222 can be next generation eNBs (i.e., gNBs) that can provide evolved universal terrestrial radio access (E-UTRA) user plane and control plane protocol terminations toward UEs 210, and that can be connected to a 5G core network (5GC) 230 via an NG interface.

Any of the RAN nodes 222 can terminate an air interface protocol and can be the first point of contact for UEs 210. In some implementations, any of the RAN nodes 222 can fulfill various logical functions for the RAN 220 including, but not limited to, radio network controller (RNC) functions such as radio bearer management, uplink and downlink dynamic radio resource management and data packet scheduling, and mobility management. UEs 210 can be configured to communicate using orthogonal frequency-division multiplexing (OFDM) communication signals with each other or with any of the RAN nodes 222 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals can comprise a plurality of orthogonal subcarriers.

In some implementations, a downlink resource grid can be used for downlink transmissions from any of the RAN nodes 222 to UEs 210, and uplink transmissions can utilize similar techniques. The grid can be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements (REs). Each resource block can comprise a collection of resource elements; in the frequency domain, this can represent the smallest quantity of resources that currently can be allocated. There are several different physical downlink channels that are conveyed using such resource blocks.

Further, RAN nodes 222 can be configured to wirelessly communicate with UEs 210, and/or one another, over a licensed medium (also referred to as the “licensed spectrum” and/or the “licensed band”), an unlicensed shared medium (also referred to as the “unlicensed spectrum” and/or the “unlicensed band”), or combination thereof. A licensed spectrum can correspond to channels or frequency bands selected, reserved, regulated, etc., for certain types of wireless activity (e.g., wireless telecommunication network activity), whereas an unlicensed spectrum can correspond to one or more frequency bands that are not restricted for certain types of wireless activity. Whether a particular frequency band corresponds to a licensed medium or an unlicensed medium can depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 210 and the RAN nodes 222 can operate using stand-alone unlicensed operation, licensed assisted access (LAA), enhanced LAA (eLAA), and/or further eLAA (feLAA) mechanisms. In such implementations, UEs 210 and the RAN nodes 222 can perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations can be performed according to a listen-before-talk (LBT) protocol.

The PDSCH can carry user data and higher layer signaling to UEs 210. The physical downlink control channel (PDCCH) can carry information about the transport format and resource allocations related to the PDSCH channel, among other things. The PDCCH can also inform UEs 210 about the transport format, resource allocation, and hybrid automatic repeat request (HARQ) information related to the uplink shared channel. Typically, downlink scheduling (e.g., assigning control and shared channel resource blocks to UE 210 within a cell) can be performed at any of the RAN nodes 222 based on channel quality information fed back from any of UEs 210. The downlink resource assignment information can be sent on the PDCCH used for (e.g., assigned to) each of UEs 210.

One or more of the techniques described herein can UE 210 to monitor UL traffic of an application or wireless link, detect an increase in UL traffic, and communicate with the network (e.g., base station 222, satellite 260, etc.,) to dynamically increase UL resources. The increase in UL resource can include a change in the number of UL slots per frame. In doing so, UE 210 can determine the UL requirements of the application, assess a current usage of UL resources, and more. For example, UE 210 can verify that DL resources are underused, before requesting an increase in UL resource. UL performance can thus be increased without a meaningful decrease in DL performance, as the increase in UL resources can be achieved by a decrease DL resources. Dynamically increasing the UL resources can enable the UE to improve UL performance commensurate with the requirements or preferences of applications that generate significant UL traffic, engage in edge compute offloading (e.g., application servers 240), and more. Many other aspects and examples are also described herein.

The RAN nodes 222 can be configured to communicate with one another via interface 223. In implementations where the system is an LTE system, interface 223 can be an X2 interface. In NR systems, interface 223 can be an Xn interface. The X2 interface can be defined between two or more RAN nodes 222 (e.g., two or more eNBs/gNBs or a combination thereof) that connect to evolved packet core (EPC) or CN 230, or between two eNBs connecting to an EPC. In some implementations, the X2 interface can include an X2 user plane interface (X2-U) and an X2 control plane interface (X2-C). The X2-U can provide flow control mechanisms for user data packets transferred over the X2 interface and can be used to communicate information about the delivery of user data between eNBs or gNBs. For example, the X2-U can provide specific sequence number information for user data transferred from a master eNB (MeNB) to a secondary eNB (SeNB); information about successful in sequence delivery of PDCP packet data units (PDUs) to a UE 210 from an SeNB for user data; information of PDCP PDUs that were not delivered to a UE 210; information about a current minimum desired buffer size at the SeNB for transmitting to the UE user data; and the like. The X2-C can provide intra-LTE access mobility functionality (e.g., including context transfers from source to target eNBs, user plane transport control, etc.), load management functionality, and inter-cell interference coordination functionality.

As shown, RAN 220 can be connected (e.g., communicatively coupled) to CN 230. CN 230 can comprise a plurality of network elements 232, which are configured to offer various data and telecommunications services to customers/subscribers (e.g., users of UEs 210) who are connected to the CN 230 via the RAN 220. In some implementations, CN 230 can include an evolved packet core (EPC), a 5G CN (5GC), and/or one or more additional or alternative types of CNs. The components of the CN 230 can be implemented in one physical node or separate physical nodes including components to read and execute instructions from a machine-readable or computer-readable medium (e.g., a non-transitory machine-readable storage medium). In some implementations, network function virtualization (NFV) can be utilized to virtualize any or all the above-described network node roles or functions via executable instructions stored in one or more computer-readable storage mediums (described in further detail below).

A logical instantiation of the CN 230 can be referred to as a network slice, and a logical instantiation of a portion of the CN 230 can be referred to as a network sub-slice. Network function virtualization (NFV) architectures and infrastructures can be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

As shown, CN 230, application servers 240, and external networks 250 can be connected to one another via interfaces 234, 236, and 238, which can include IP network interfaces. Application servers 240 can include one or more server devices or network elements (e.g., virtual network functions (VNFs) offering applications that use IP bearer resources with CN 230 (e.g., universal mobile telecommunications system packet services (UMTS PS) domain, LTE PS data services, etc.). Application servers 240 can also, or alternatively, be configured to support one or more communication services (e.g., voice over IP (VOIP sessions, push-to-talk (PTT) sessions, group communication sessions, social networking services, etc.) for UEs 210 via the CN 230. Similarly, external networks 250 can include one or more of a variety of networks, including the Internet, thereby providing the mobile communication network and UEs 210 of the network access to a variety of additional services, information, interconnectivity, and other network features.

Satellites 260 can communicate with UEs 210 via service link or wireless interface 262 and/or RAN 220 via feeder links or wireless interfaces 264 (depicted individually as 264-1 and 264-2). In some implementations, satellite 260 can operate as a passive or transparent network relay node regarding communications between UE 210 and the terrestrial network (e.g., RAN 220). In some implementations, satellite 260 can operate as an active or regenerative network node such that satellite 260 can operate as a base station to UEs 210 (e.g., as a base station of RAN 220). In some implementations, satellites 260 can communicate with one another via a direct wireless interface (e.g., 266) or an indirect wireless interface (e.g., via RAN 220 using interfaces 264-1 and 264-2).

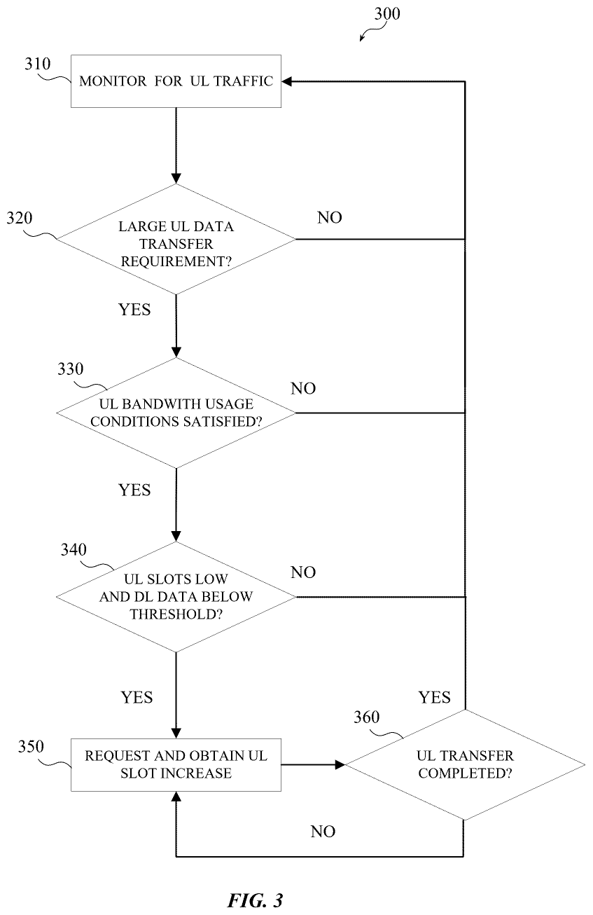

FIG. 3 is a diagram of an example of a process 300 for a smart UL resource management according to one or more implementations described herein. Process 300 can be implemented by UE 210, baseband circuitry, radio frequency circuitry, and/or one or more other types of devices and/or components described herein. In some implementations, some or all of process 300 can be performed by one or more other systems, devices, or components, including one or more of the devices of FIG. 2, such as base station 222 and satellite 260. Additionally, process 300 can include one or more fewer, additional, differently ordered and/or arranged operations than those shown in FIG. 3. In some implementations, some or all of the operations of process 300 can be performed independently, successively, simultaneously, etc., of one or more of the other operations of process 300. As such, the techniques described herein are not limited to a number, sequence, arrangement, timing, etc., of the operations or processes depicted in FIG. 3.

Process 300 can be performed by UE 210 in communication with base station 222 at the edge of the mobile network in an area of limited coverage, where UL bandwidth is limited. Process 300 can be performed when UE 210 uses applications that generate significant UL traffic, has limited coverage, engages in mobile edge compute scenarios (e.g., where UE 210 is to offload data and processes to edge servers, application servers 240, and/or another type of network server), is limited to communicating with satellites 260, and so on. An example of applications that can generate significant UL traffic and/or engage in mobile edge commuting can include video game application, VR applications, AR applications, and other data-intensive applications. Process 300 can also apply to satellite communication scenarios, where UL limitations can present a bottleneck for data transfer and increasing UL bandwidth.

As shown, process 300 can include monitoring the communication link for UL traffic (block 310). For example, UE 210 can be in communication with base station 222 or a satellite 260. UE 210 can monitor for the presence of UL traffic to base station 222 or satellite 260. Monitoring the communication link for UL traffic can UE 210 detecting UL traffic and optionally determining whether UL throughput is approaching the UL bandwidth of the communication link.

Process 300 can include determining whether UE 210 prefers, is configured for, or requires large UL data transfer (block 320). For example, UE 210 can determine application data requirements with respect to the communication link and specifically the detected UL traffic. For example, UE 210 can determine whether an application executing on UE 210 prefers, is configured for, or requires a large UL data transfer. As previously described, many types of applications can involve, be configured for, or require large UL transfers. In some examples, UE 210 can determine that an application prefers, is configured for, or requires large UL transfer of the data transmitted by the application exceeds a threshold amount of data. In some examples, UE 210 can determine that an application prefers, is configured for, or requires large UL transfer if the application includes the capability of offloading data-intensive tasks to the network. UL traffic, UL data transfers, UL traffic thresholds, and similar terminology, can be indicated, represented, or quantified in one or more ways, such as bandwidth, throughput, latency, transfer rate, latency, bits/unit of time, etc.

When UE determines that no application requires transfer of a large amount of data to the network (e.g., a data amount that does not exceed the threshold size) (block 320—NO), process 300 can continue monitoring UL traffic (block 310). In some examples, the threshold amount of data that constitutes a large transfer can be referred to herein as a bandwidth, a transfer size, transfer rate, throughput, and so on. When UE 210 determines that an application prefers, is configured for, or requires the transfer of a large amount of data to the network (e.g., a data amount that exceeds a threshold size) (block 320—YES), process 300 can include determining whether UL bandwidth usage conditions for the communication link are satisfied (block 330).

For example, UE 210 can determine whether the UL bandwidth usage conditions for the communication link are met. In some examples, to determine whether UL bandwidth usage conditions are met by the communication link, UE 210 can access a combined UL traffic (e.g., UL traffic from all applications providing UL traffic) from UE 210 to measure throughput. UE 210 can sample the combined throughput at a predetermined interval to determine whether additional UL bandwidth is preferred, beneficial, or otherwise warranted. UE 210 can determine that additional UL bandwidth is preferred based on the link if, for example, the sampled throughput exceeds a throughput threshold. In some examples, the sampling interval can be 1.2 seconds(s) or a different interval of time.

Additionally, or alternatively, UE 210 can determine whether UL bandwidth usage conditions are met by the communication link. UE 210 can determine a size of the transfer from the UL traffic. In some examples, UE 210 can determine the size of the transfer based on a packet header information such as a hypertext transfer protocol (HTTP) content length in a header of a UL frame. In some implementations, UL bandwidth conditions are met when the size of the transfers exceeds a threshold transfer size. UL bandwidth conditions can be met when a combined throughput exceeds a throughput threshold and/or the transfer size exceeds a size threshold.

When the UL bandwidth conditions are not met (e.g., if none of these conditions are satisfied) (block 330—NO), process 300 can continue monitoring UL traffic usage (block 310). For example, UE 210 can continue monitoring UL traffic usage when the UL bandwidth conditions are not met or satisfied. When the UL bandwidth conditions are met (e.g., either because the combined throughput exceeds a throughput threshold or the UL transfer size exceeds a size threshold) (block 330—YES), process 300 can include evaluating the existing frame configuration and DL traffic (block 340). For example, UE 210 can determine UL resources, such as the slot and frame configuration, and evaluate DL traffic.

UE 210 can determine whether a portion or share of UL slots per frame is low relative to DL slots. For example, when implementing 5G communication standards, 20% of the slots per frame allocated to UE 210 can be allocated as UL resources by default. The relatively small portion or share of UL slots in the frame can result in limited UL bandwidth. The limited UL bandwidth can cause greater UL latency compared to another communication standard, such as WiFi®. The latency can increase with the size of the transfer and the cadence of the transmission. The limited UL bandwidth can also cause increased power consumption for 5G links compared to, for example, WiFi®. The disparity in power consumption can also increase with the cadence of the transmission such that at higher frequencies, a UL transfer of a large size on a 5G link can consume more than an order of magnitude in energy (as expressed in nanojoule per byte (nJ/byte) than the equivalent transfer on, for example, a WiFi® link.

UE 210 can also evaluate whether DL throughput is below a DL throughput threshold. Ensuring that DL throughput is below a DL throughput threshold can ensure that UL throughput can be increased with minimal effect on DL throughput. When the share of UL slots is at or above the threshold share of UL slots (e.g., 20%) or DL throughput is above the DL throughput threshold (block 340—NO), the process 300 can return to monitoring UL traffic (block 310).

When the portion or share of UL slots is at or below the threshold portion or share of UL slots (e.g., 20%) and DL throughput is below the DL throughput threshold (block 340—YES), process 300 can include requesting additional UL resources (block 350). For example, UE 210 can request additional UL resources to increase UL throughput. The request can include a request for an increase in the number and/or share of UL slots per frame. UE 210 can, for example, request such resources upon determining that application requirements are satisfied (e.g., that an application requires a large UL data transfer) (block 320), UL transfer size exceeds a transfer size threshold (block 330), and that DL usage is below a DL usage threshold (block 340).

In some examples, UE 210 can request an increase from UL slots at 20% per frame to 21%-80% per frame. An increase in the portion or share of UL slots can represent a significant increase in UL bandwidth and throughput for a connection between UE 210 and base station 222. The resulting increase in UL resources can significantly improve latency on the link including for larger size transfers and higher transmission cadences. Increased UL resources can also decrease power consumption for 5G links, as more data can be transferred in the UL direction over the same or less time, thereby making the communication link more energy-efficient. An increase in UL resources can thus enable, facilitate, or enhance the operation of UE applications for mobile edge compute applications, communications with satellites 260, or other scenarios.

As shown, process 300 can include determining whether UL transfer is completed (block 360). For example, UE 210 can determine whether a UL data transfer is complete. When UL transfer is complete (block 360—YES), the process 300 (e.g., UE 210) can return to monitoring UL traffic (block 310). When UL transfer is not complete (block 360-NO), process 300 continue using the additional UL resources for UL traffic and/or can send additional requests to obtain additional UL resources (e.g., a further increase in UL resources) for the UL traffic (block 350).

The operation of process 300 can be implemented in one or more ways. In some implementations, for example, operations directed toward UL traffic, resources, usages, and/or thresholds can also, or alternatively, be applied to DL traffic, resources, usages, and thresholds. Further, operations directed toward DL traffic, resources, usages, and/or thresholds can also, or alternatively, be applied to UL traffic, resources, usages, and/or thresholds.

The operation of process 300 can be implemented in one or more ways. In some implementations, for example, operations directed toward UL traffic, resources, usages, and/or thresholds can also, or alternatively, be applied to DL traffic, resources, usages, and thresholds. Further, operations directed toward DL traffic, resources, usages, and/or thresholds can also, or alternatively, be applied to UL traffic, resources, usages, and/or thresholds. As such, process 300 is provided as a non-limiting example of one or more of the techniques described herein.

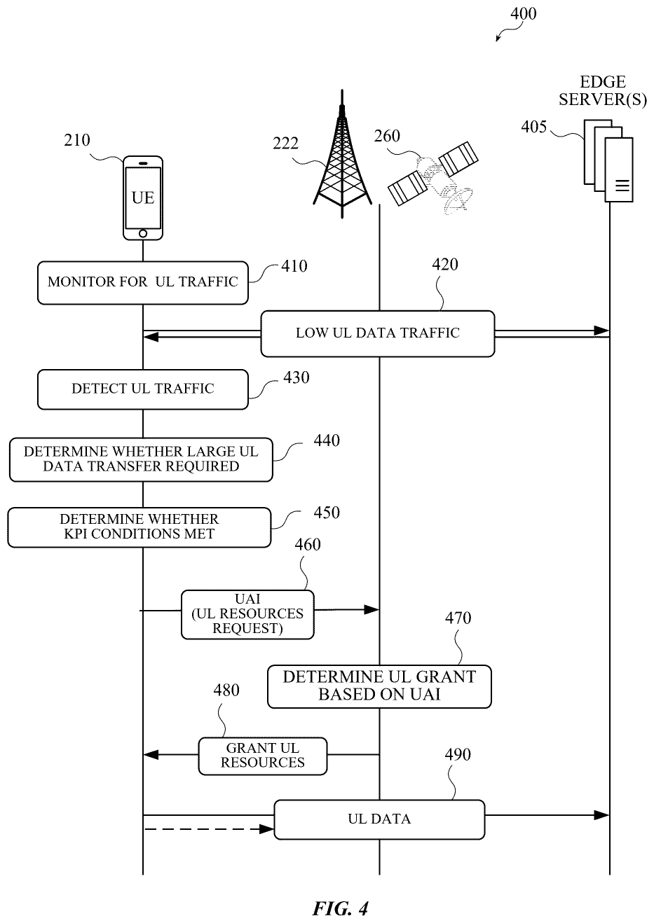

FIG. 4 is a diagram of an example of a process 400 for a smart uplink resource management according to one or more implementations described herein. Process 400 can be implemented by UE 210 and one or more base stations 222 and/or satellites 260, and one or more edge servers 405. Additionally, process 400 can include one or more fewer, additional, differently ordered and/or arranged operations than those shown in FIG. 4. In some implementations, some or all of the operations of process 400 can be performed independently, successively, simultaneously, etc., of one or more of the other operations of process 400. As such, the techniques described herein are not limited to a number, sequence, arrangement, timing, etc., of the operations or processes depicted in FIG. 4.

Edge servers 405 can include one or more server devices configured to perform or execute tasks for UE 210. Edge servers 405 can receive information and instructions from UE 210 regarding a process or procedure, perform the process or procedure on behalf of UE 210, and return results or other data resulting from the process or procedure. Edge servers 405 can be implemented within CN 230 or outside of CN 230. Edge servers 405 can be an example of application servers 240 and/or one or more other types of server devices or network elements.

As shown, process 400 can further include UE 210 monitoring for the presence of UL traffic (block 410). In particular, UE 210 can detect whether an application on UE 210 is transmitting data (e.g., to base station 222, satellite 260, and/or edge server(s) 405). Process 400 can include UE 210 transmitting to and receiving data from base station 222, satellite 260, and/or edge server 405 (block 420). In the case of the communication with the base station 222, the connection can established at the edge of the mobile network, where throughput can be lower due to a decrease in signal strength.

For example, when implementing 5G communication standards, 20% of the slots per frame allocated to UE 210 can be allocated as UL resources by default. The relatively small portion or share of UL slots in the frame can result in limited UL bandwidth. The limited UL bandwidth can cause greater UL latency compared to another communication standard, such as WiFi®. The latency can increase with the size of the transfer and the cadence of the transmission. The limited UL bandwidth can also cause increased power consumption for 5G links compared to, for example, WiFi®. The disparity in power consumption can also increase with the cadence of the transmission such that at higher frequencies, a UL transfer of a large size on a 5G link can consume more than an order of magnitude in energy (as expressed in nanojoule per byte (nJ/byte) than the equivalent transfer on, for example, a WiFi® link. UL traffic can exhibit similar constraints when UE 210 is in communication with satellite 260.

Process 400 can include UE 210 detecting the presence of UL traffic (block 430). UE 210 can monitor UL traffic associated with an application transmitting data to base station 222, satellite 260, and/or edge server 405. Process 400 can also, or alternatively, include UE 210 determining whether the application running on UE 210 and/or UL traffic transmitted by the application involves large UL transfers to the base station 222, satellite 260, and or edge server(s) (405) (block 440). As previously described, many types of application can prefer, be configured for, or require large UL transfer. In some examples, UE 210 can determine that an application requires large UL transfer of the data transmitted by the application exceeds a threshold amount of data. In some examples, UE 210 can determine that an application prefers, is configured for, or requires large UL transfer when the application includes the capability of offloading data-intensive tasks to the network.

As shown, process 400 can including UE 210 determining whether KPIs or KPI conditions for requesting additional UL resources from the network are met (block 450). KPIs, or KPI conditions, can include whether combined UL throughput from UE 210 is greater than or equal to (or exceeds) a UL throughput threshold or whether a UL transfer size is greater than or equal to (or exceeds) a UL size threshold. When either condition is met, UE 210 can evaluate additional KPI conditions, such as determining a frame condition (e.g., whether a share of UL slots in the frame is low relative to DL slots, whether DL throughput is below a DL throughput threshold, etc.). KPI conditions for requesting additional UL resources can be met when, for example, combined UL throughput from UE 210 exceeds a UL throughput threshold or a transfer size to the network exceeds a size threshold, and/or when the share of UL slots in the frame is low relative to DL slots (e.g., at or below a certain UL slot threshold, such as 20% of the frame) while DL throughput is below a DL throughput threshold.

As shown, process 400 can include UE 210 requesting from the network additional UL resources (block 460). For example, UE 210 can transmit to base station 222 or satellite 260 a request to increase the number of UL slots in the frame when UE 210 determines that KPI conditions are satisfied. The requested increase can be from, for example, 20% to 60%, 70%, or 80%, or anywhere therebetween. In some examples, UE 210 can transmit to the network configuration information using a UE assistance information (UAI) or another type of RRC layer 3 (L3) message. The UAI message can include a custom signature identifying UE 210 and configuration information of UE 210. The UAI message can also include a request to increase UL slots (e.g., from 20% to 60-80%). The UAI message can enable the network to configure UE 210 for UL transmission with a high number of UL slots. In some examples, the UAI can include UE thermal information (e.g., a temperature of UE or a component thereof) and power consumption information (e.g., a power consumption rate of UE 210 or a component thereof) that can further enable the network to configure UE 210 for more efficient UL transmissions. In some examples, the UAI message can further include a request to dynamically enable low latency features on a best effort basis. In some examples, the request for additional UL resource can be transmitted to the network via layer 1 (L1) and/or layer 2 (L2) messaging instead of L3 RRC signaling.

As shown, process 400 can include the base station 222 and/or satellite 260 determining a UL grant based on the UAI (block 470). For example, base station 222 and/or satellite 260 can determine whether to grant the requested UL resources indicated by UE 210. In some implementations, base station 222 and/or satellite 260 can determine the UL grant based on information pertaining to UE 210 (e.g., UE capabilities, UE conditions, a priority or rank of UE 210, a priority or rank of the application executed by UE 210, a priority or rank of a service or account associated with UE 210, etc.). Additionally, or alternatively, base station 222 and/or satellite 260 can determine the UL grant based on information pertaining to RAN conditions (e.g., an interference, signal strength, hardware configuration, resource availability, etc.).

As shown, process 400 can include base station 222 and/or satellite 260 granting to the UE 210 additional UL resources (block 480). For example, base station 222 and/or satellite 260 can transmit to UE 210 a configured or dynamic grant to increase UL resources allocated to UE 210. This can include an increase in the number of UL slots per frame of the communication link between UE 210 and base station 222 and/or satellite 260.

Process 400 can include the UE 210 transmitting UL data to base station 222, satellite 260, and/or edge servers 405 (block 490). The UL transmission can be enabled or facilitated by the additional UL resources granted by the network to UE 210, such as the increase in numbers or share of UL slots in the frame. In some examples, the additional UL resources provide UE 210 an enhanced ability to offload large, data-intensive tasks to edge servers, 405 which can facilitate the functioning of compute-intensive applications. In some examples, the increased number of UL slots can enable application to transfer larger amounts of data to the network via satellite 260 (e.g., without involving edge servers 405). As previously described, the additional resources can enable applications to UL to satellites 260 more than, for example, data relating to roadside assistance services or other emergency services.

The operation of process 400 can be implemented in one or more ways. In some implementations, for example, operations directed toward UL traffic, resources, usages, and/or thresholds can also, or alternatively, be applied to DL traffic, resources, usages, and thresholds. Further, operations directed toward DL traffic, resources, usages, and/or thresholds can also, or alternatively, be applied to UL traffic, resources, usages, and/or thresholds. As such, process 400 is provided as a non-limiting example of one or more of the techniques described herein.

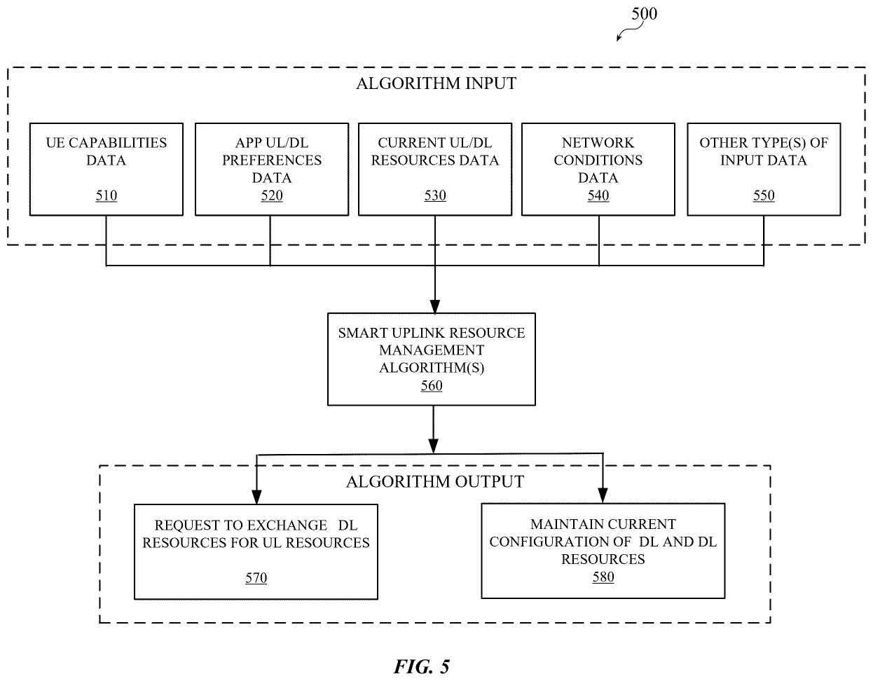

FIG. 5 is a diagram of an example 500 of a smart UL resource management algorithm according to one or more implementations described herein. As shown, example 500 several types of inputs that can be provided to an algorithm to produce one or more types of outputs. Examples of the input data can include UE capabilities data 510, application UL/DL preferences data 520, current UL/DL resources data 530, network conditions data 540, and/or one or more other types of data 550. An example of the algorithm can include smart UL resources management algorithms 560. Examples of the outputs can include a request to exchange DL resources for UL resources 570 and maintain current configuration of UL and DL resources 580.

UE capabilities data 510 can include one or more types of information relating to the capabilities and/or configuration of UE 210. The UE capabilities can pertain to an ability of UE 210 to engage in smart UL resource management as described herein. Examples of UE capabilities data 510 can include an indication of an ability of UE 210 to transmit and receive information via a wireless interface. This can include bandwidth information, transmission power information, battery power information, channel information, communication standards information, etc. (including one or more of the thresholds described herein).

Application UL/DL preferences data 520 can include one or more types of information relating to the capabilities, preferences, requirements, and/or configuration of an application being executed by UE 210. The application can include functionality to generate data to be transmitted to base station 222 and/or satellite 260 via UL resources. Examples of application UL/DL preferences data 520 can include a preference or configuration of an application to use UL resources and/or conditions (e.g., a latency, throughput, etc.) under which UL resources are to be used. Some or all of application UL and DL preferences data 520 can be determined based on an application type. For example, a VR application can require significant UL bandwidth to upload data reflecting the complexity of a user's interaction with a virtual environment, whereas a streaming application can require significant DL bandwidth to stream higher resolution media content. Application UL/DL preferences data 520 can include one or more of the thresholds described herein and/or information to be applied to the thresholds. Additional examples can include a rate, requirement, or other configuration for generating UL data to be transmitted via UL resources.

Current UL/DL resources data 530 can include one or more types of information relating to a current allocation of UL and/or DL resources of UE 210. Application UL/DL preferences data 520 can include an indication of time and frequency resources allocated to UE 210. Application UL/DL preferences data 520 can include a total amount of time and frequency resources allocated to UE 210 and/or time and frequency resources allocated to different applications being executed by UE 210 or different services being accessed by UE 210. Application UL/DL preferences data 520 can be particular to different bandwidths, bandwidth parts (BWP), physical channels, logical channels, and/or operational layers (e.g., L1, L2, L3, etc.). UL and/or DL resources data 530 can include UL bandwidth conditions, such UL throughput and UL transfer size. For example, smart UL resource management algorithm 560 can determine whether UL throughput exceeds a throughput threshold and whether UL transfer size exceeds a size transfer size threshold. The UL and/or DL resources data 530 can also include DL bandwidth usage. In particular, the smart uplink management algorithm 500 can determine whether DL throughput is under a threshold (e.g., to evaluate whether and to what extent an increase in UL throughput can affect DL bandwidth). Current UL/DL resources data 530 can include default UL resources allocated to UE 210, additional UL resources allocated to UE 210, and/or further UL resources allocated to UE 210 (see, e.g., UE 210 requesting additional resources at 360 of FIG. 3).

Network conditions data 540 can include one or more types of information relating to a status, signal, channel, or other communication characteristics relating to communications between UE 210 and a RAN 220. For example, network conditions data 540 can include an SNR, RTT, latency, measurements, reference signal received power (RSRP), signal interference, etc. Network conditions data 540 can include information measured and/or determined by UE 210, information received by UE 210 from another UE 210, information received by UE 210 from a RAN 220 (e.g., base station 222, satellite 260, etc.), or any combination thereof. Network conditions data 540 can include information and instructions (including one or more of the thresholds described herein) for determining network conditions relating to smart UL resource management as described herein.

One or more other types of data 550 can include one or more types of information relating to, facilitating, or enabling smart UL resource management as described herein. Other types of data 550 can include, for example, information relating to one or more other devices connected to or in the vicinity of UE 210. This can include instances of one or more inputs 510-540 associated with the other devices. UE 210 can be configured to receive information from the other devices via a D2D connection, such as Bluetooth®, SL, etc. UE 210 can use the information to be further informed about an ability of RAN 220 to modify UL resources allocations, signaling strengths, interference, and other network conditions measured by the other devices, and so on. Other type of data 550 can include, for example, one or more KPIs, which can be variables that reflect UE conditions, application conditions, resource allocation conditions, network conditions, and more. In some examples, KPIs can include device temperature, device power consumption, device battery level, and other device parameters that can affect UE performance.

Smart UL resources management algorithms 560 can include information and instructions smart UL resource management as described herein. Smart UL resources management algorithms 560 can be stored in a memory of UE 210 and/or a component of UE 210, such as a memory of baseband circuitry. Similarly, smart UL resources management algorithms 560 can include a software program or set of software programs executed by a processor of UE 210 and/or a processor of baseband circuitry. Smart UL resources management algorithms 560 can cause UE 210 and/or baseband circuitry to generate information, apply information to one or more thresholds, evaluate circumstances based on the information and thresholds, and produce one or more outputs.

For example, smart UL resources management algorithms 560 can cause UE 210 and/or baseband circuitry to execute an application, monitor UL traffic associated with the application, determine whether a transfer size of the UL traffic is greater than or equal to a transfer size threshold, and when the transfer size of the UL traffic is greater than or equal to the transfer size threshold, determine whether a DL usage is below a DL usage threshold. Smart UL resources management algorithms 560 can further cause UE 210 and/or baseband circuitry to communicate a request for additional UL resources when the DL usage is below the DL usage threshold, receive and/or process the additional resources in response to the request, and generate and/or communicate UL traffic using the additional UL resources. Additionally, smart UL resources management algorithms 560 can generate an output comprising a request to exchange DL resources for UL resources 570 (see, e.g., request a UL slot increase at 350 of FIG. 3) and/or maintain current configuration of UL and DL resources 580 (see, e.g., return to monitoring UL traffic at 310 of FIG. 3).

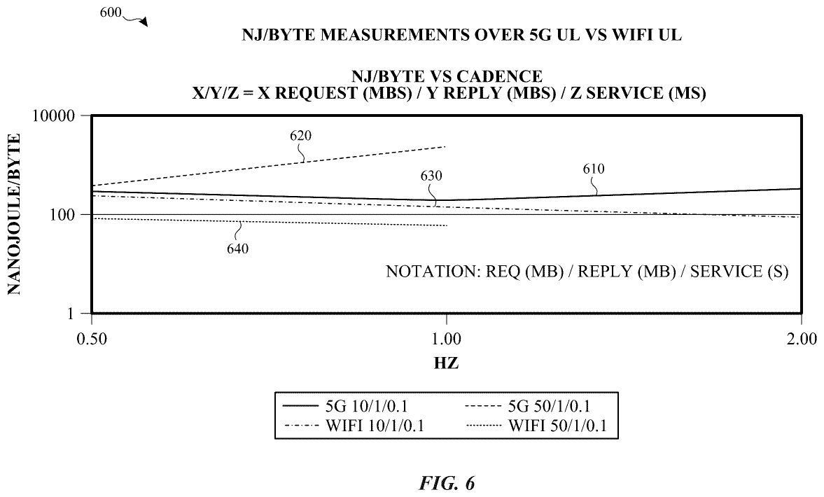

FIG. 6 is a diagram of an example of a graph 600 of an energy performance of smart uplink resource management according to one or more implementations described herein. Graph 600 can depict KPI conditions (e.g., UE energy performance (and battery level)) for determining whether to request additional UL resources. Graph 600 can represent an energy performance of UL transmissions when a share of UL slots per frame is 20% (e.g., under normal 5G UL conditions and before additional UL resources are requested and granted). For example, graph 600 can include the energy consumption (e.g., in nJ/byte) of UL transmissions as a function of cadence (horizontal axis) and transfer size (vertical axis) for both 5G UL transmissions and WiFi® UL transmissions. Curve 610 can represent an energy consumption (e.g., in nJ/byte) of a 5G UL transfer of a smaller size (e.g., 10 megabytes (MB)) as a function of cadence (e.g., frequency). Energy expenditure and/or efficiency of a 5G UL transmission is comparable to WiFi® for smaller transfer sizes at a lower cadence, as can be seen with WiFi® curve 630. At higher cadences, WiFi® can be slightly more energy efficient. With large sizes however (e.g., 50 MB), as shown by 5G curve 620 and WiFi® curve 640, 5G UL transmissions can be considerably less efficient than WiFi® and can become less efficient as cadence increases. Accordingly, in some examples, UE 210 can base the determination of whether to request additional UL resources on UE energy consumption and whether the current UL conditions or KPIs are causing or indicating excessive power consumption at UE 210.

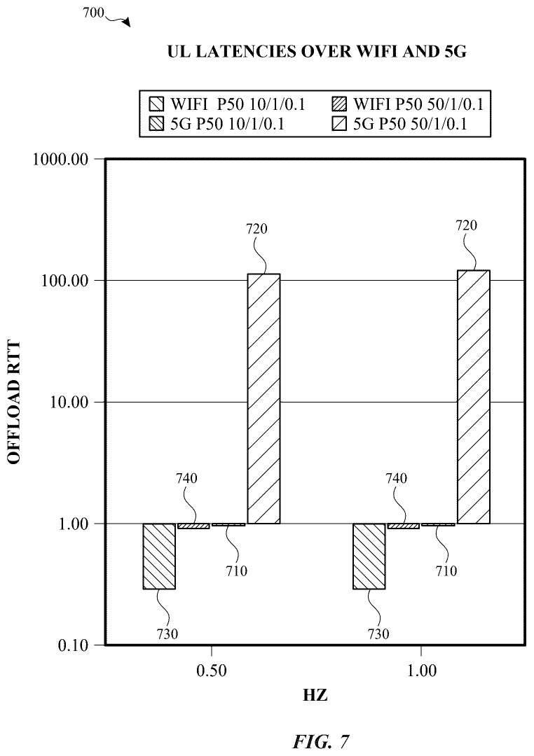

FIG. 7 is a diagram of an example of graph 700 of UL transmissions latencies under various conditions according to one or more implementations described herein. Graph 700 can help demonstrate KPIs, and/or KPI conditions, for determining whether to request additional UL resources. The KPIs, and/or KPI conditions, can include a latency of the link between UE 210 and base station 222 and/or satellite 260. Graph 700 can represent a latency of UL transmissions when the portion or share of UL slots per frame is 20% (e.g., normal 5G UL conditions and before additional UL resources are requested and granted). For example, graph 700 shows a latency of UL links as a function of cadence and transfer size for both a 5G UL transmission and a WiFi® UL transmission. For example, for a 10 MB transfer, the latency over 5G (at 710) can be greater than a latency over WiFi® (at 730). For larger transfers (e.g., 50 MB), the difference between 5G (at 720) and WiFi® (at 740) can be greater than two orders of magnitude. Thus, 5G or other types of communication standards can exhibit significant UL latency for certain transfers. UE 210 can determine that additional UL resources are preferred based latency as a KPI (e.g., based on latency being high or excessive) and request an increase in the number of UL slots to reduce the latency and improve UL performance.

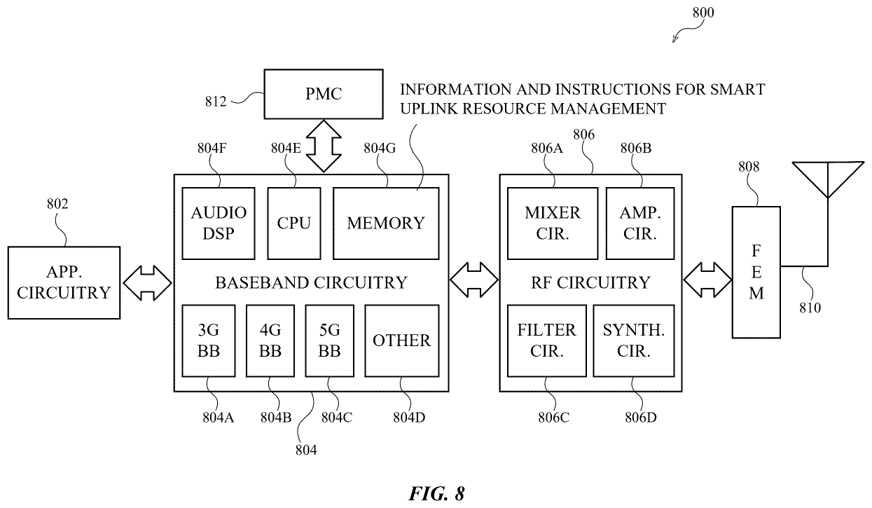

FIG. 8 is a diagram of an example of components of a device 800 according to one or more implementations described herein. In some implementations, device 800 can include application circuitry 802, baseband circuitry 804, RF circuitry 806, front-end module (FEM) circuitry 808, one or more antennas 810, and power management circuitry (PMC) 812 coupled together at least as shown. In some implementations, device 800 can include fewer elements (e.g., a RAN node may not utilize application circuitry 802, and can instead include a processor/controller to process data received from a core network. In some implementations, device 800 can include additional elements such as, for example, memory/storage, display, camera, sensor (including one or more temperature sensors, such as a single temperature sensor, a plurality of temperature sensors at different locations in device 800, etc.), or input/output (I/O) interface. In other implementations, the components described below can be included in more than one device (e.g., said circuitries can be separately included in more than one device for cloud-RAN (C-RAN) implementations).

Application circuitry 802 can include one or more application processors. For example, application circuitry 802 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on device 800. In some implementations, processors of application circuitry 802 can process data packets received from a core network.

Baseband circuitry 804 can include circuitry such as, but not limited to, one or more single-core or multi-core processors. Baseband circuitry 804 can include one or more baseband processors or control logic to process baseband signals received from a receive signal path of RF circuitry 806 and to generate baseband signals for a transmit signal path of RF circuitry 806. Baseband circuitry 804 can interface with application circuitry 802 for generation and processing of the baseband signals and for controlling operations of RF circuitry 806. For example, in some implementations, baseband circuitry 804 can include a 3G baseband processor 804A, a 4G baseband processor 804B, a 5G baseband processor 804C, or other baseband processor(s) 804D for other existing generations, generations in development or to be developed in the future (e.g., 5G, 6G, 7G, etc.). Baseband circuitry 804 (e.g., one or more of baseband processors 804A-D) can handle various radio control functions that enable communication with one or more radio networks via RF circuitry 806. In other implementations, some or all of the functionality of baseband processors 804A-D can be included in modules stored in memory 804G and executed via a central processing unit (CPU) 804E. The radio control functions can include, but are not limited to, signal modulation/demodulation, encoding/decoding, radio frequency shifting, etc. In some implementations, modulation/demodulation circuitry of baseband circuitry 804 can include Fast-Fourier Transform (FFT), precoding, or constellation mapping/de-mapping functionality. In some implementations, encoding/decoding circuitry of baseband circuitry 804 can include convolution, tail-biting convolution, turbo, Viterbi, or low-density parity check (LDPC) encoder/decoder functionality. Implementations of modulation/demodulation and encoder/decoder functionality are not limited to these examples and can include other suitable functionality in other implementations.

In some implementations, memory 804G can receive and/or store information and instructions for enabling UE 210 and/or baseband circuitry 804 to monitor UL traffic of an application or wireless link, detect an increase in UL traffic, and communicate with the network (e.g., base station 222, satellite 260, etc.) to dynamically increase UL resources. The increase in UL resource can include a change in the number of UL slots per frame. In doing so, UE 210 and/or baseband circuitry 804 can determine the UL requirements of the application, assess a current usage of UL resources, and more. For example, UE 210 and/or baseband circuitry 804 can verify that DL resources are underused, before requesting an increase in UL resource. UL performance can thus be increased without a meaningful decrease in DL performance, as the increase in UL resources can be achieved by a decrease DL resources. Dynamically increasing the UL resources can enable the UE to improve UL performance commensurate with the requirements or preferences of applications that generate significant UL traffic, engage in edge compute offloading (e.g., application servers 240), and more. These and many other features and examples are described herein.

In some implementations, baseband circuitry 804 can include one or more audio digital signal processor(s) (DSP) 804F. Audio DSP 804F can include elements for compression/decompression and echo cancellation and can include other suitable processing elements in other implementations. Components of baseband circuitry 804 can be suitably combined in a single chip, a single chipset, or disposed on a same circuit board in some implementations. In some implementations, some or all of the constituent components of baseband circuitry 804 and application circuitry 802 can be implemented together such as, for example, on a system on a chip (SOC).

In some implementations, baseband circuitry 804 can provide for communication compatible with one or more radio technologies. For example, in some implementations, baseband circuitry 804 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which baseband circuitry 804 is configured to support radio communications of more than one wireless protocol can be referred to as multi-mode baseband circuitry.

RF circuitry 806 can enable communication with wireless networks using modulated electromagnetic radiation through a non-solid medium. In various implementations, RF circuitry 806 can include switches, filters, amplifiers, etc., to facilitate the communication with the wireless network. RF circuitry 806 can include a receive signal path which can include circuitry to down-convert RF signals received from FEM circuitry 808 and provide baseband signals to baseband circuitry 804. RF circuitry 806 can also include a transmit signal path which can include circuitry to up-convert baseband signals provided by baseband circuitry 804 and provide RF output signals to FEM circuitry 808 for transmission.

In some implementations, the receive signal path of RF circuitry 806 can include mixer circuitry 806A, amplifier circuitry 806B and filter circuitry 806C. In some implementations, the transmit signal path of RF circuitry 806 can include filter circuitry 806C and mixer circuitry 806A. RF circuitry 806 can also include synthesizer circuitry 806D for synthesizing a frequency for use by mixer circuitry 806A of the receive signal path and the transmit signal path. In some implementations, mixer circuitry 806A of the receive signal path can be configured to down-convert RF signals received from FEM circuitry 808 based on the synthesized frequency provided by synthesizer circuitry 806D. Amplifier circuitry 806B can be configured to amplify the down-converted signals and filter circuitry 806C can be a low-pass filter (LPF) or band-pass filter (BPF) configured to remove unwanted signals from the down-converted signals to generate output baseband signals. Output baseband signals can be provided to baseband circuitry 804 for further processing. In some implementations, the output baseband signals can be zero-frequency baseband signals, although this may not be a requirement. In some implementations, mixer circuitry 806A of the receive signal path can comprise passive mixers, although the scope of the implementations is not limited in this respect.

In some implementations, mixer circuitry 806A of the transmit signal path can be configured to up-convert input baseband signals based on the synthesized frequency provided by synthesizer circuitry 806D to generate RF output signals for FEM circuitry 808. The baseband signals can be provided by baseband circuitry 804 and can be filtered by filter circuitry 806C. In some implementations, mixer circuitry 806A of the receive signal path and mixer circuitry 806A of the transmit signal path can include two or more mixers and can be arranged for quadrature down conversion and up conversion, respectively. In some implementations, mixer circuitry 806A of the receive signal path and mixer circuitry 806A of the transmit signal path can include two or more mixers and can be arranged for image rejection. In some implementations, mixer circuitry 806A of the receive signal path and mixer circuitry 806A can be arranged for direct down conversion and direct up conversion, respectively. In some implementations, mixer circuitry 806 of the receive signal path and mixer circuitry 806A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, RF circuitry 806 can include analog-to-digital converter (ADC) and digital-to-analog converter (DAC) circuitry and baseband circuitry 804 can include a digital baseband interface to communicate with RF circuitry 806.

In some dual-mode implementations, a separate radio IC circuitry can be provided for processing signals for each spectrum, although the scope of the implementations is not limited in this respect. In some implementations, synthesizer circuitry 806D can be a fractional-N synthesizer or a fractional N/N+1 synthesizer, although the scope of the implementations is not limited in this respect as other types of frequency synthesizers can be suitable. For example, synthesizer circuitry 806D can be a delta-sigma synthesizer, a frequency multiplier, or a synthesizer comprising a phase-locked loop with a frequency divider.

Synthesizer circuitry 806D can be configured to synthesize an output frequency for use by mixer circuitry 806A of RF circuitry 806 based on a frequency input and a divider control input. In some implementations, synthesizer circuitry 806D can be a fractional N/N+1 synthesizer. In some implementations, frequency input can be provided by a voltage-controlled oscillator (VCO). Divider control input can be provided by either baseband circuitry 804 or the applications circuitry 802 depending on the desired output frequency. In some implementations, a divider control input (e.g., N) can be determined from a look-up table based on a channel indicated by the applications circuitry 802.

Synthesizer circuitry 806D of RF circuitry 806 can include a divider, a delay-locked loop (DLL), a multiplexer, and a phase accumulator. In some implementations, the divider can be a dual modulus divider (DMD), and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 806D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, RF circuitry 806 can include an in-phase/quadrature (I/Q)/polar converter.

FEM circuitry 808 can include a receive signal path which can include circuitry configured to operate on RF signals received from one or more antennas 810, amplify the received signals and provide the amplified versions of the received signals to RF circuitry 806 for further processing. FEM circuitry 808 can also include a transmit signal path which can include circuitry configured to amplify signals for transmission provided by RF circuitry 806 for transmission by one or more of the one or more antennas 810. In various implementations, the amplification through the transmit or receive signal paths can be done solely in RF circuitry 806, solely in FEM circuitry 808, or in both RF circuitry 806 and FEM circuitry 808.

In some implementations, FEM circuitry 808 can include a transmit/receive switch to switch between transmit mode and receive mode operation. FEM circuitry 808 can include a receive signal path and a transmit signal path. The receive signal path of FEM circuitry 808 can include an low noise amplifier to amplify received RF signals and provide the amplified received RF signals as an output (e.g., to RF circuitry 806). The transmit signal path of FEM circuitry 808 can include a power amplifier to amplify input RF signals (e.g., provided by RF circuitry 806), and one or more filters to generate RF signals for subsequent transmission (e.g., by one or more of one or more antennas 810).

In some implementations, PMC 812 can manage power provided to baseband circuitry 804. In particular, PMC 812 can control power-source selection, voltage scaling, battery charging, or direct current (DC) to DC (DC-to-DC) conversion. PMC 812 can often be included when device 800 is capable of being powered by a battery, for example, when device 800 is included in a UE. PMC 812 can increase the power conversion efficiency while providing desirable implementation size and heat dissipation characteristics.

While FIG. 8 shows PMC 812 coupled only with baseband circuitry 804. However, in other implementations, PMC 812 can be additionally or alternatively coupled with, and perform similar power management operations for, other components such as, but not limited to, application circuitry 802, RF circuitry 806, or FEM circuitry 808.

In some implementations, PMC 812 can control, or otherwise be part of, various power saving mechanisms of device 800. For example, if device 800 is in an RRC_Connected state, where device 800 is still connected to the RAN node as device 800 expects to receive traffic shortly, then device 800 can enter a state known as discontinuous reception mode (DRX) after a period of inactivity. During this state, device 800 can power down for brief intervals of time and thus save power.

If there is no data traffic activity for an extended period of time, then device 800 can transition off to an RRC_Idle state, where device 800 disconnects from the network and does not perform operations such as channel quality feedback, handover, etc. Device 800 can go into a very low power state and device 800 can perform paging where again device 800 periodically can wake up to listen to the network and then power down again. Device 800 may not receive data in this state; in order to receive data, device 800 can transition back to RRC_Connected state.

An additional power saving mode can allow a device to be unavailable to the network for periods longer than a paging interval (ranging from seconds to a few hours). During this time, the device 800 can be unreachable to the network and can power down completely. Any data sent during this time can incur a large delay and device 800 can assume the delay is acceptable.

Processors of application circuitry 802 and processors of baseband circuitry 804 can be used to execute elements of one or more instances of a protocol stack. For example, processors of baseband circuitry 804, alone or in combination, can be used execute Layer 3, Layer 2, or Layer 1 functionality, while processors of baseband circuitry 804 can utilize data (e.g., packet data) received from these layers and further execute Layer 4 functionality (e.g., transmission communication protocol (TCP) and user datagram protocol (UDP) layers). As referred to herein, Layer 3 can comprise a radio resource control layer. As referred to herein, Layer 2 can comprise a medium access control layer, a radio link control layer, and a packet data convergence protocol layer, described in further detail below. As referred to herein, Layer 1 can comprise a physical layer of a UE/RAN node.

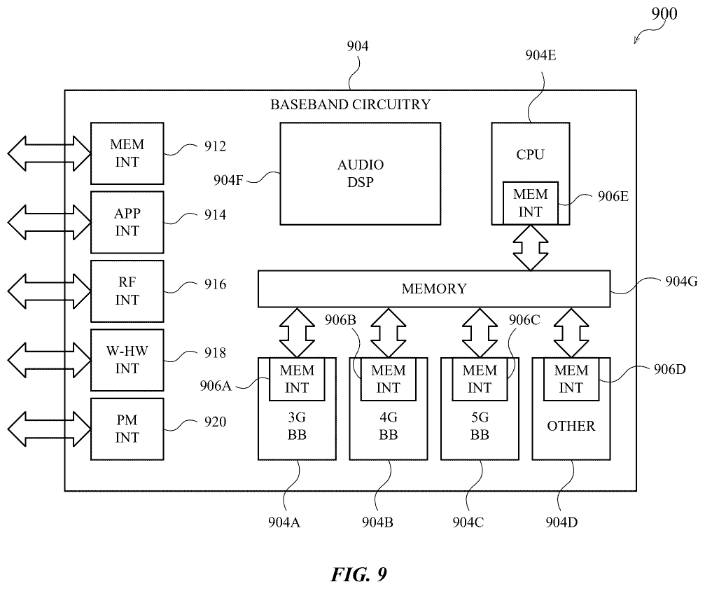

FIG. 9 is a diagram of example interfaces 900 of baseband circuitry according to one or more implementations described herein. One or more components or features of example interfaces 900 can correspond to one or more components or features described above or elsewhere. Baseband circuitry 904 can comprise processors 904A, 904B, 904C, 904D, and 904E and a memory 904G utilized by said processors. Each of processors 904A, 904B, 904C, 904D, and 904E can include a memory interface, 906A, 906B, 906C, 906D, and 906E, respectively, to send/receive data to/from memory 904G. Baseband circuitry can be a component of a UE and/or another type of device or system capable of transmitting and/or receiving wireless signals.

Baseband circuitry 904 can further include one or more interfaces to communicatively couple to other circuitries/devices, such as memory interface 912 (e.g., an interface to send/receive data to/from memory external to baseband circuitry 904), an application circuitry interface 914 (e.g., an interface to send/receive data to/from the application circuitry as described herein), an RF circuitry interface 916, a wireless hardware connectivity interface 918 (e.g., an interface to send/receive data to/from near field communication components, Bluetooth® components (e.g., Bluetooth® Low Energy), Wi-Fi® components, and other communication components), and a power management interface 920 (e.g., an interface to send/receive power or control signals to/from a PMC).

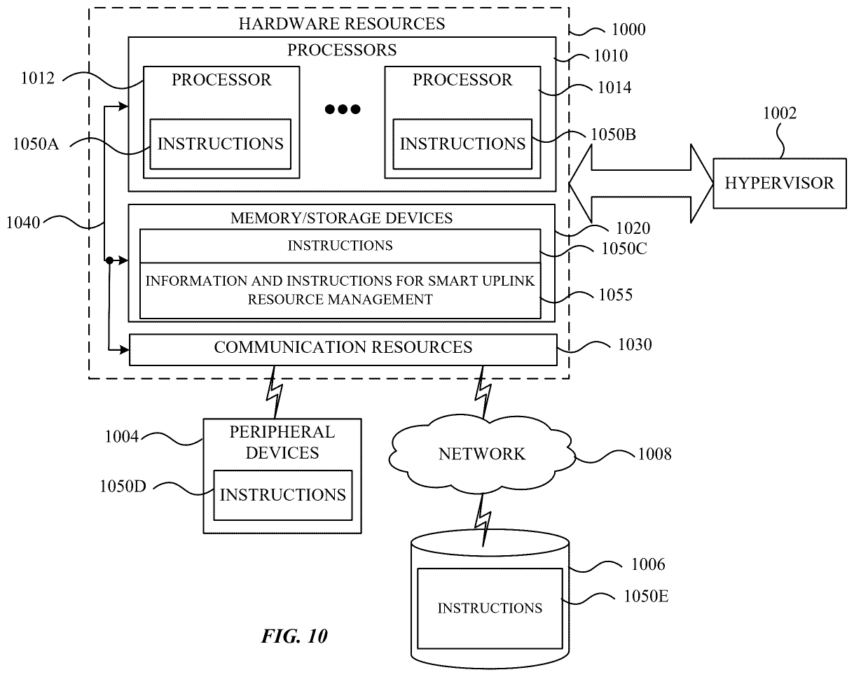

FIG. 10 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 10 shows a diagrammatic representation of hardware resources 1000 including one or more processors 1010 (or processor cores), one or more memory/storage devices 1020, and one or more communication resources 1030, each of which can be communicatively coupled via a bus 1040. For implementations where node virtualization or network function virtualization is utilized, a hypervisor can be executed to provide an execution environment for one or more network slices/sub-slices to utilize hardware resources 1000. Hardware resources 1000 can interact with hypervisor 1002. For example, hypervisor 1002 can schedule or otherwise manage hardware resource 1000.

Processors 1010 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) can include, for example, a processor 1012 and a processor 1014.

Memory/storage devices 1020 can include main memory, disk storage, or any suitable combination thereof. Memory/storage devices 1020 can include, but are not limited to any type of volatile or non-volatile memory such as dynamic random-access memory (DRAM), static random-access memory (SRAM), erasable programmable read-only memory (EPROM), electrically erasable programmable read-only memory (EEPROM), flash memory, solid-state storage, etc.

In some implementations, memory/storage devices 1020 receive and/or store information and instructions 1055 to enable UE 210, and/or one or more components thereof, to monitor UL traffic of an application or wireless link, detect an increase in UL traffic, and communicate with the network (e.g., base station 222, satellite 260, etc.,) to dynamically increase UL resources. The increase in UL resource can include a change in the number of UL slots per frame. In doing so, UE 210 can determine the UL requirements of the application, assess a current usage of UL resources, and more. For example, UE 210 can verify that DL resources are underused, before requesting an increase in UL resource. UL performance can thus be increased without a meaningful decrease in DL performance, as the increase in UL resources can be achieved by a decrease DL resources. Dynamically increasing the UL resources can enable the UE to improve UL performance commensurate with the requirements or preferences of applications that generate significant UL traffic, engage in edge compute offloading (e.g., application servers 240), and more. These and many other features and examples are described herein.

Communication resources 1030 can include interconnection or network interface components or other suitable devices to communicate with one or more peripheral devices 1004 or one or more databases 1006 via a network 1008. For example, communication resources 1030 can include wired communication components (e.g., for coupling via a universal serial bus), cellular communication components, near field communication components, Bluetooth® components (e.g., Bluetooth® Low Energy), Wi-Fi® components, and other communication components.

Instructions 1050A, 1050B, 1050C, 1050D, and/or 1050E can comprise software, a program, an application, an applet, an app, or other executable code for causing at least any of processors 1010 to perform any one or more of the methodologies discussed herein. Instructions 1050 can reside, completely or partially, within at least one of processors 1010 (e.g., within a cache memory), memory/storage devices 1020, or any suitable combination thereof. Furthermore, any portion of instructions 1050A-E can be transferred to hardware resources 1000 from any combination of peripheral devices 1004 or databases 1006. Accordingly, memory of processors 1010, memory/storage devices 1020, peripheral devices 1004, and databases 1006 are examples of computer-readable and machine-readable media.

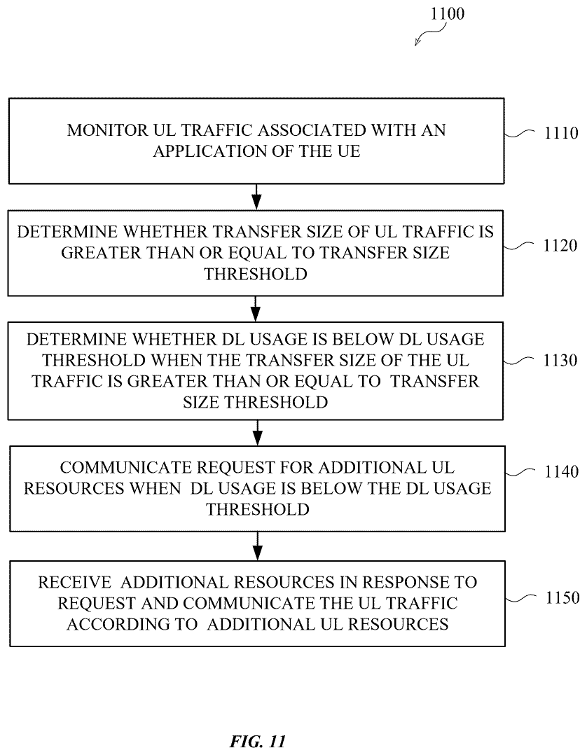

FIG. 11 is a diagram of an example process 1100 for a smart UL resource management according to one or more implementations described herein. Process 1100 can be implemented by UE 210 and/or one or more components thereof, such as baseband circuitry 804. In some implementations, some or all of process 1100 can be performed by one or more other systems or devices, including one or more of the devices of FIG. 2 such as base station 222 and satellite 260. Additionally, process 1100 can include one or more fewer, additional, differently ordered and/or arranged operations than those shown in FIG. 11. In some implementations, some or all of the operations of process 1100 can be performed independently, successively, simultaneously, etc., of one or more of the other operations of process 1100. As such, the techniques described herein are not limited to a number, sequence, arrangement, timing, etc., of the operations or processes depicted in FIG. 11.

Process 1100 can include monitoring UL traffic associated with an application of a UE (block 1110). Process 1100 can include determining whether a transfer size of UL traffic is greater than or equal to a transfer size threshold (block 1120). Process 1100 can include, when the transfer size of the UL traffic is greater than or equal to the transfer size threshold, determining whether a downlink (DL) usage is below a DL usage threshold (block 1130). Process 1100 can include, when the DL usage is below the DL usage threshold, communicating a request for additional UL resources (block 1140). Process 1100 can include receiving the additional resources in response to the request and communicating the UL traffic using the additional UL resources (block 1150). Process 1100 can also, or alternatively, include one or more operations, features, or characteristics of any of the examples described herein.

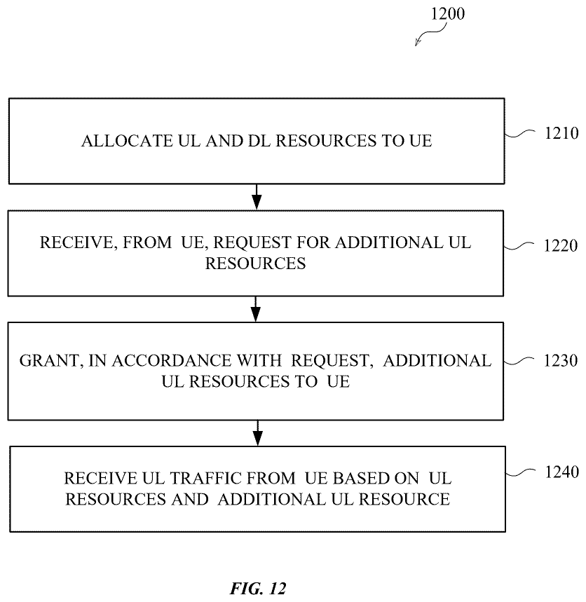

FIG. 12 is a diagram of an example process 1200 for a smart UL resource management according to one or more implementations described herein. Process 1200 can be implemented by RAN 220, base station 222, satellite 260, and/or one or more other types of RAN devices. In some implementations, some or all of process 1200 can be performed by one or more other systems, devices, and/or components described herein, such as UE 210, baseband circuitry 804, RF circuitry 806, etc. Additionally, process 1200 can include one or more fewer, additional, differently ordered and/or arranged operations than those shown in FIG. 12. In some implementations, some or all of the operations of process 1200 can be performed independently, successively, simultaneously, etc., of one or more of the other operations of process 1200. As such, the techniques described herein are not limited to a number, sequence, arrangement, timing, etc., of the operations or processes depicted in FIG. 12.

Process 1200 can include allocating UL and DL resources to UE 210 (block 1210). Process 1200 can include receiving, from UE 210, a request for additional UL resources (block 1220). Process 1200 can include granting, in accordance with the request, the additional UL resources to UE 210 (block 1230). Process 1200 can include receive UL traffic from UE 210 based on the UL resources and the additional UL resource (block 1240). Process 1200 can also, or alternatively, include one or more operations, features, or characteristics of any of the examples described herein.

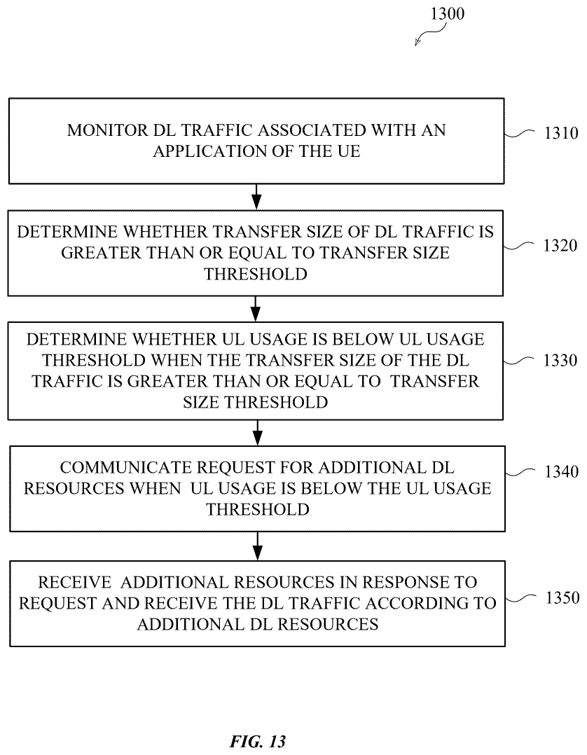

FIG. 13 is a diagram of an example process 1300 for a smart DL resource management according to one or more implementations described herein. Process 1300 can be implemented by UE 210 and/or one or more components thereof, such as baseband circuitry 804. In some implementations, some or all of process 1300 can be performed by one or more other systems or devices, including one or more of the devices of FIG. 2 such as base station 222 and satellite 260. Additionally, process 1300 can include one or more fewer, additional, differently ordered and/or arranged operations than those shown in FIG. 13. In some implementations, some or all of the operations of process 1300 can be performed independently, successively, simultaneously, etc., of one or more of the other operations of process 1300. As such, the techniques described herein are not limited to a number, sequence, arrangement, timing, etc., of the operations or processes depicted in FIG. 13.

Process 1300 can include monitoring DL traffic associated with an application of a UE (block 1310). Process 1300 can include determining whether a transfer size of DL traffic is greater than or equal to a transfer size threshold (block 1320). Process 1300 can include, when the transfer size of the DL traffic is greater than or equal to the transfer size threshold, determining whether a uplink (UL) usage is below a UL usage threshold (block 1330). Process 1300 can include, when the UL usage is below the UL usage threshold, communicating a request for additional DL resources (block 1340). Process 1300 can include receiving the additional resources in response to the request and receiving the DL traffic using the additional DL resources (block 1350). Process 1300 can also, or alternatively, include one or more operations, features, or characteristics of any of the examples described herein.

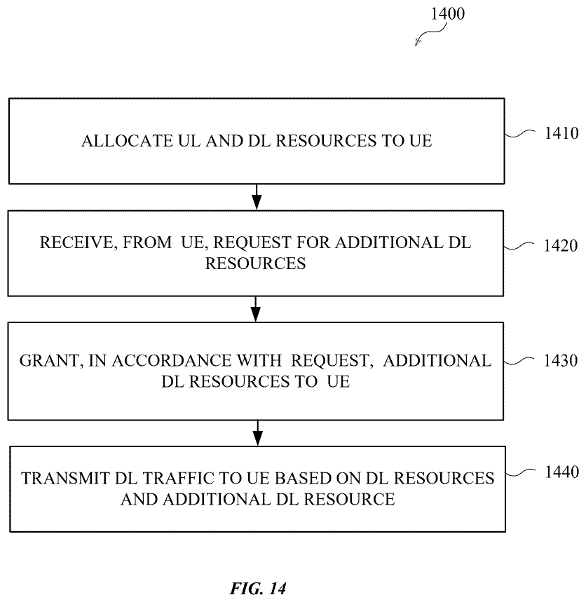

FIG. 14 is a diagram of an example process 1400 for a smart DL resource management according to one or more implementations described herein. Process 1400 can be implemented by RAN 220, base station 222, satellite 260, and/or one or more other types of RAN devices. In some implementations, some or all of process 1400 can be performed by one or more other systems, devices, and/or components described herein, such as UE 210, baseband circuitry 804, RF circuitry 806, etc. Additionally, process 1400 can include one or more fewer, additional, differently ordered and/or arranged operations than those shown in FIG. 14. In some implementations, some or all of the operations of process 1400 can be performed independently, successively, simultaneously, etc., of one or more of the other operations of process 1400. As such, the techniques described herein are not limited to a number, sequence, arrangement, timing, etc., of the operations or processes depicted in FIG. 14.

Process 1400 can include allocating UL and DL resources to UE 210 (block 1410). Process 1400 can include receiving, from UE 210, a request for additional DL resources (block 1420). Process 1400 can include granting, in accordance with the request, the additional DL resources to UE 210 (block 1430). Process 1400 can include transmit DL traffic to UE 210 based on the DL resources and the additional DL resource (block 1440). Process 1400 can also, or alternatively, include one or more operations, features, or characteristics of any of the examples described herein.

Examples and/or implementations herein may include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which may also include one or more of the examples described herein, a user device (UE) may comprise a memory, and one or more processors configured to, when executing instructions stored in the memory, cause the UE to: monitor uplink (UL) traffic associated with an application of the UE; determine whether a transfer size of UL traffic is greater than or equal to a transfer size threshold; when the transfer size of the UL traffic is greater than or equal to the transfer size threshold, determine whether a downlink (DL) usage is below a DL usage threshold; when the DL usage is below the DL usage threshold, communicate a request for additional UL resources; receive the additional UL resources in response to the request; and communicate the UL traffic using the additional UL resources.

In example 2, which may also include one or more of the examples described herein, the one or more processors are further configured to cause the UE to: determine whether the application is configured to generate application UL traffic that is greater than or equal to an UL application threshold, and when the UL application traffic that is greater than or equal to the UL application threshold, communicate the request for the additional UL resources.

In example 3, which may also include one or more of the examples described herein, the one or more processors are further configured to cause the UE to: when the UL application traffic is less than the UL application threshold, continue monitoring the UL traffic associated with the application.

In example 4, which may also include one or more of the examples described herein, the one or more processors are further configured to cause the UE to: determine that the transfer size of the UL traffic is greater than or equal to the transfer size threshold when throughput sampled at a predetermined time interval is greater than or equal to a throughput threshold.

In example 5, which may also include one or more of the examples described herein, the one or more processors are further configured to cause the UE to: determine that the transfer size of the UL traffic is greater than or equal to the transfer size threshold when a size of the UL traffic reaches a threshold size based on a hypertext transfer protocol (HTTP) content length in a header of a UL frame of the UL traffic.

In example 6, which may also include one or more of the examples described herein, the one or more processors are further configured to cause the UE to: when the transfer size of the UL traffic does less than the transfer size threshold, continue monitoring the UL traffic associated with the application.

In example 7, which may also include one or more of the examples described herein, the one or more processors are further configured to cause the UE to: when the DL usage is below the DL usage threshold, determine an amount of resources corresponding to UL resources relative to a total amount of UL and DL resources allocated to the application; determine whether the amount of resources corresponding to the UL resources is less than or equal to a threshold amount of resources; and communicate the request for the additional UL resources when the amount of resources corresponding to the UL resources is less than or equal to the threshold amount of resources.

In example 8, which may also include one or more of the examples described herein, the amount of resources corresponding to the UL resources comprises a number of UL slots per frame relative to a number of DL slots per frame.

In example 9, which may also include one or more of the examples described herein, the amount of resources corresponding to the UL resources comprises a number of UL slots per frame relative to a total number of slots per frame.

In example 10, which may also include one or more of the examples described herein, the threshold amount of resources is twenty percent (20%).

In example 11, which may also include one or more of the examples described herein, the request for additional resources includes a request for an increase in a number of UL slots per frame relative to a total number of slots per frame.

In example 12, which may also include one or more of the examples described herein, the request for additional resources includes a request for a decrease in a number of DL slots per frame.

In example 13, which may also include one or more of the examples described herein, the one or more processors are further configured to cause the UE to: when the amount of resources corresponding to the UL resources is greater than the threshold amount of resources, determine whether the amount of resources corresponding to the UL resources is less than or equal to a second threshold amount of resources that is different than the threshold amount of resources; and communicate a second request for the additional UL resources when the amount of resources corresponding to the UL resources is less than or equal to the second threshold amount of resources, the second request being different than the request for the additional UL resources.

In example 14, which may also include one or more of the examples described herein, the amount of resources corresponding to the UL resources comprises a number of UL slots per frame relative to a total number of slots per frame and the second threshold amount of resources is 80%.

In example 15, which may also include one or more of the examples described herein, the one or more processors are further configured to cause the UE to: when the amount of resources corresponding to the UL resources is not less than or equal to a threshold amount of resources, continue monitoring the UL traffic associated with the application.

In example 16, which may also include one or more of the examples described herein, the one or more processors are further configured to cause the UE to: determine whether one or more UE key performance indicator (KPIs) are satisfied; and communicate the request for the additional UL resources when the one or more of the KPIs are satisfied.

In example 17, which may also include one or more of the examples described herein, the or more KPIs are satisfied when: a UE temperature is less than or equal to a threshold UE temperature, a baseband circuitry temperature is less than or equal to a threshold baseband circuitry temperature, a UE battery level is less than or equal to a threshold battery level, a UL latency is greater than or equal to a latency threshold, or a combination thereof.

In example 18, which may also include one or more of the examples described herein, a method, performed by a device, may comprise: monitoring uplink (UL) traffic associated with an application of the device; determining whether a transfer size of UL traffic is greater than or equal to a transfer size threshold; when the transfer size of the UL traffic is greater than or equal to the transfer size threshold, determining whether a downlink (DL) usage is below a DL usage threshold; when the DL usage is below the DL usage threshold, communicating a request for additional UL resources; receiving the additional UL resources in response to the request; and communicating the UL traffic using the additional UL resources.

In example 19, which may also include one or more of the examples described herein, a radio access network (RAN) device may comprise: a memory; and one or more processors configured to, when executing instructions stored in the memory, cause the RAN device to: allocate uplink (UL) and downlink (DL) resources to a user equipment (UE); receive, from the UE, a request for additional UL resources; grant, in accordance with the request, the additional UL resources to the UE; and receive UL traffic from the UE based on the UL resources and the additional UL resource.

In example 20, which may also include one or more of the examples described herein, the one or more processors are further configured to cause the RAN device to: grant the additional UL resources by increasing a number of UL slots per frame and decreasing a corresponding number of DL slots per frame.

In example 21, which may also include one or more of the examples described herein, a user device (UE) may comprise: a memory; and one or more processors configured to, when executing instructions stored in the memory, cause the UE to: monitor downlink (DL) traffic associated with an application of the UE; determine whether a transfer size of DL traffic is greater than or equal to a transfer size threshold; when the transfer size of the DL traffic is greater than or equal to the transfer size threshold, determine whether a uplink (UL) usage is below a UL usage threshold; when the UL usage is below the UL usage threshold, communicate a request for additional DL resources; receive the additional DL resources in response to the request; and receive the DL traffic using the additional DL resources.

In example 22, which may also include one or more of the examples described herein, the one or more processors are further configured to cause the UE to: determine whether the application is configured to receive application DL traffic that is greater than or equal to a DL application threshold, and when the DL application traffic that is greater than or equal to the DL application threshold, communicate the request for the additional DL resources.

In example 23, which may also include one or more of the examples described herein, the one or more processors are further configured to cause the UE to: when the DL application traffic is less than the DL application threshold, continue monitoring the DL traffic associated with the application.

In example 24, which may also include one or more of the examples described herein, the one or more processors are further configured to cause the UE to: determine that the transfer size of the DL traffic is greater than or equal to the transfer size threshold when throughput sampled at a predetermined time interval is greater than or equal to a throughput threshold.

In example 25, which may also include one or more of the examples described herein, the one or more processors are further configured to cause the UE to: determine that the transfer size of the DL traffic is greater than or equal to the transfer size threshold when a size of the DL traffic reaches a threshold size based on a hypertext transfer protocol (HTTP) content length in a header of a DL frame of the DL traffic.

In example 26, which may also include one or more of the examples described herein, the one or more processors are further configured to cause the UE to: when the transfer size of the DL traffic is less than the transfer size threshold, continue monitoring the DL traffic associated with the application.

In example 27, which may also include one or more of the examples described herein, the one or more processors are further configured to cause the UE to: when the UL usage is below the UL usage threshold, determine an amount of resources corresponding to DL resources relative to a total amount of UL and DL resources allocated to the application; determine whether the amount of resources corresponding to the DL resources is less than or equal to a threshold amount of resources; and communicate the request for the additional DL resources when the amount of resources corresponding to the DL resources is less than or equal to the threshold amount of resources.

In example 28, which may also include one or more of the examples described herein, the amount of resources corresponding to the DL resources comprises a number of DL slots per frame relative to a number of UL slots per frame.

In example 29, which may also include one or more of the examples described herein, the amount of resources corresponding to the DL resources comprises a number of DL slots per frame relative to a total number of slots per frame.

In example 30, which may also include one or more of the examples described herein, the threshold amount of resources is twenty percent (80%).

In example 31, which may also include one or more of the examples described herein, the request for additional resources includes a request for an increase in a number of DL slots per frame relative to a total number of slots per frame, such that a total DL slots per from exceeds 80% of the total number of slots per frame.

In example 32, which may also include one or more of the examples described herein, the request for additional resources includes a request for a decrease in a number of UL slots per frame to be less than 20% of a total number of slots per frame.

In example 33, which may also include one or more of the examples described herein, the one or more processors are further configured to cause the UE to: when the amount of resources corresponding to the DL resources is greater than the threshold amount of resources, determine whether the amount of resources corresponding to the DL resources is less than or equal to a second threshold amount of resources that is different than the threshold amount of resources; and communicate a second request for the additional DL resources when the amount of resources corresponding to the DL resources is less than or equal to the second threshold amount of resources, the second request being different than the request for the additional DL resources.

In example 34, which may also include one or more of the examples described herein, the amount of resources corresponding to the DL resources comprises a number of DL slots per frame relative to a total number of slots per frame and the second threshold amount of resources is 20%.

In example 35, which may also include one or more of the examples described herein, the one or more processors are further configured to cause the UE to: when the amount of resources corresponding to the DL resources is not less than or equal to a threshold amount of resources, continue monitoring the DL traffic associated with the application.

In example 36, which may also include one or more of the examples described herein, the one or more processors are further configured to cause the UE to: determine whether one or more UE key performance indicator (KPIs) are satisfied; and communicate the request for the additional DL resources when the one or more of the KPIs are satisfied.

In example 37, which may also include one or more of the examples described herein, the one or more KPIs are satisfied when: a UE temperature is less than or equal to a threshold UE temperature, a baseband circuitry temperature is less than or equal to a threshold baseband circuitry temperature, a UE battery level is less than or equal to a threshold battery level, a DL latency is greater than or equal to a latency threshold, or a combination thereof.

In example 38, which may also include one or more of the examples described herein, a method, performed by a device, may comprise: monitoring downlink (DL) traffic associated with an application of the device; determining whether a transfer size of DL traffic is greater than or equal to a transfer size threshold; when the transfer size of the DL traffic is greater than or equal to the transfer size threshold, determining whether a uplink (UL) usage is below a UL usage threshold; when the UL usage is below the UL usage threshold, communicating a request for additional DL resources; receiving the additional DL resources in response to the request; and receiving the DL traffic using the additional DL resources.

In example 39, which may also include one or more of the examples described herein, a radio access network (RAN) device may comprise: a memory; and one or more processors configured to, when executing instructions stored in the memory, cause the RAN device to: allocate uplink (UL) and downlink (DL) resources to a user equipment (UE); receive, from the UE, a request for additional DL resources; grant, in accordance with the request, the additional DL resources to the UE; and transmit DL traffic to the UE based on the DL resources and the additional DL resource.

In example 40, which may also include one or more of the examples described herein, the one or more processors are further configured to cause the RAN device to: grant the additional DL resources by increasing a number of DL slots per frame and decreasing a corresponding number of UL slots per frame.

The examples discussed above also extend to method, computer-readable medium, and means-plus-function claims and implementations, an of which may include one or more of the features or operations of any one or combination of the examples mentioned above.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. A user device (UE), comprising:
a memory; and
one or more processors configured to, when executing instructions stored in the memory, cause the UE to:
monitor uplink (UL) traffic associated with an application of the UE;
determine whether a transfer size of UL traffic is greater than or equal to a transfer size threshold;
when the transfer size of the UL traffic is greater than or equal to the transfer size threshold,
determine whether a downlink (DL) usage is below a DL usage threshold;
when the DL usage is below the DL usage threshold,
communicate a request for additional UL resources;
receive the additional UL resources in response to the request; and
communicate the UL traffic using the additional UL resources.

2. The UE of claim 1, wherein the one or more processors are further configured to cause the UE to:
determine whether the application is configured to generate application UL traffic that is greater than or equal to an UL application threshold, and
when the UL application traffic that is greater than or equal to the UL application threshold,
communicate the request for the additional UL resources.

3. The UE of claim 2, wherein the one or more processors are further configured to cause the UE to:
when the UL application traffic is less than the UL application threshold, continue monitoring the UL traffic associated with the application.

4. The UE of claim 1, wherein the one or more processors are further configured to cause the UE to:
determine that the transfer size of the UL traffic is greater than or equal to the transfer size threshold when throughput sampled at a predetermined time interval is greater than or equal to a throughput threshold.

5. The UE of claim 1, wherein the one or more processors are further configured to cause the UE to:
determine that the transfer size of the UL traffic is greater than or equal to the transfer size threshold when a size of the UL traffic reaches a threshold size based on a hypertext transfer protocol (HTTP) content length in a header of a UL frame of the UL traffic.

6. The UE of claim 1, wherein the one or more processors are further configured to cause the UE to:
when the transfer size of the UL traffic does less than the transfer size threshold, continue monitoring the UL traffic associated with the application.

7. The UE of claim 1, wherein the one or more processors are further configured to cause the UE to:
when the DL usage is below the DL usage threshold,
determine an amount of resources corresponding to UL resources relative to a total amount of UL and DL resources allocated to the application;
determine whether the amount of resources corresponding to the UL resources is less than or equal to a threshold amount of resources; and
communicate the request for the additional UL resources when the amount of resources corresponding to the UL resources is less than or equal to the threshold amount of resources.

8. The UE of claim 7, wherein the amount of resources corresponding to the UL resources comprises a number of UL slots per frame relative to a number of DL slots per frame.

9. The UE of claim 7, wherein the amount of resources corresponding to the UL resources comprises a number of UL slots per frame relative to a total number of slots per frame.

10. The UE of claim 9, wherein the threshold amount of resources is twenty percent (20%).

11. The UE of claim 7, wherein the request for additional resources includes a request for an increase in a number of UL slots per frame relative to a total number of slots per frame.

12. The UE of claim 7, wherein the request for additional resources includes a request for a decrease in a number of DL slots per frame.

13. The UE of claim 7, wherein the one or more processors are further configured to cause the UE to:
when the amount of resources corresponding to the UL resources is greater than the threshold amount of resources,
determine whether the amount of resources corresponding to the UL resources is less than or equal to a second threshold amount of resources that is different than the threshold amount of resources; and
communicate a second request for the additional UL resources when the amount of resources corresponding to the UL resources is less than or equal to the second threshold amount of resources, the second request being different than the request for the additional UL resources.

14. The UE of claim 13, wherein the amount of resources corresponding to the UL resources comprises a number of UL slots per frame relative to a total number of slots per frame and the second threshold amount of resources is 80%.

15. The UE of claim 7, wherein the one or more processors are further configured to cause the UE to:
when the amount of resources corresponding to the UL resources is not less than or equal to a threshold amount of resources,
continue monitoring the UL traffic associated with the application.

16. The UE of claim 1, wherein the one or more processors are further configured to cause the UE to:
determine whether one or more UE key performance indicator (KPIs) are satisfied; and
communicate the request for the additional UL resources when the one or more of the KPIs are satisfied.

17. The UE of claim 16, wherein the one or more KPIs are satisfied when:
a UE temperature is less than or equal to a threshold UE temperature,
a baseband circuitry temperature is less than or equal to a threshold baseband circuitry temperature,
a UE battery level is less than or equal to a threshold battery level,
a UL latency is greater than or equal to a latency threshold, or
a combination thereof.

18. A method, performed by a device, the method comprising:
monitoring uplink (UL) traffic associated with an application of the device;
determining whether a transfer size of UL traffic is greater than or equal to a transfer size threshold;
when the transfer size of the UL traffic is greater than or equal to the transfer size threshold,
determining whether a downlink (DL) usage is below a DL usage threshold;
when the DL usage is below the DL usage threshold,
communicating a request for additional UL resources;
receiving the additional UL resources in response to the request; and
communicating the UL traffic using the additional UL resources.

19. A radio access network (RAN) device, comprising:
a memory; and
one or more processors configured to, when executing instructions stored in the memory, cause the RAN device to:
allocate uplink (UL) and downlink (DL) resources to a user equipment (UE);
receive, from the UE, a request for additional UL resources;
grant, in accordance with the request, the additional UL resources to the UE; and
receive UL traffic from the UE based on the UL resources and the additional UL resource.

20. The RAN device of claim 19, wherein the one or more processors are further configured to cause the RAN device to:
grant the additional UL resources by increasing a number of UL slots per frame and decreasing a corresponding number of DL slots per frame.
